(19) United States
(12) Patent Application Publication
(10) Pub. No.: US 2025/0368300 A1
(43) Pub. Date: Dec. 4, 2025

(54) FLOATING POWER GENERATION SYSTEM

(71) Applicant: Twenty20 Energy Systems Pte Ltd, Singapore (SG)

(72) Inventors: Geoffrey A. LAWRENCE, Singapore (SG); Christopher L. HOBBS, Singapore (SG)

(21) Appl. No.: 18/876,156

(22) PCT Filed: Jun. 16, 2023
(86) PCT No.: PCT/SG2023/050431

§ 371 Date: Dec. 17, 2024

(30) Foreign Application Priority Data
Jun. 17, 2022 (AU) 2022901658

(51) Int. Cl. B63B 35/44; B63B 25/12; E02B 3/06; F02C 6/00; F03G 4/00

(52) U.S. Cl. CPC B63B 35/44; B63B 25/12; E02B 3/062; F02C 6/00; F03G 4/035; B63B 2035/444; F05D 2220/76

(57) ABSTRACT

Some embodiments relate to a power generation system. An example floating power generation system comprises: a vessel, the vessel including: a vessel frame, a hull around the vessel frame and defining fore and aft sections, and a deck supported by the vessel frame. A gas turbine may be provided on the vessel to generate electrical power from combustion of natural gas. An organic Rankine cycle (ORC) generator may be provided on the vessel to generate electrical power from heat recovery. A gas supply line may be provided on the vessel for supplying liquefied natural gas (LNG) to the gas turbine. A power supply subsystem may be provided on the vessel to receive electrical power from at least one of the gas turbine or the ORC generator and to supply power to at least one remote power sink that is away from the vessel.

### TECHNICAL FIELD

The present disclosure generally relates to a power generation system. More specifically, the present disclosure relates to a floating power generation system using liquefied natural gas.

### BACKGROUND

There exists a significant number of obstacles to providing reliable electrical power to geographically remote and rural areas, in particular at an economically viable cost. As an example, the archipelago of Papua New Guinea (PNG) consists of several islands, each of which has large rural areas in which residents are located in small decentralized communities, as well as areas of industrial use. The island terrain and topography is a challenging environment in which to operate a power transmission network. A recurring challenge facing a country such as PNG is the variation in power demand in different regions and at different times. The electrical power load is made up of decentralized smaller loads. Mining, fisheries and other similar industries create significant localized power demand but the demand exists only for specific periods of time whilst the mine is productive or the fisheries are active. At other times, the low population density generates a much smaller power demand. Current power generation solutions are not meeting these varying needs efficiently and energy costs are accordingly high.

Shortcomings of previous concepts include that they focus on larger scale power stations which provides ample capital to overcome the obstacles. Such large scale power stations require more capital than is justified in certain circumstances. Also, the larger manufacturers do not achieve a lot of financial gain by doing small plants, so they have not focused on smaller scale stations. For example, small scale stations may involve the same amount of work as a larger plant because it may have all of the same/similar components, but the benefits do not justify the required capital.

For smaller plants in remote areas, there is a need to focus on efficiency to reduce fuel delivery and eliminate or reduce, where possible, the need for consumables that incur significant to transport to the remote site. Thus it is desirable to reduce logistics costs for storage and transport of fuel (higher efficiency=less fuel=less logistics) and the same for consumables.

It is desired to address or ameliorate one or more shortcomings or disadvantages of prior power generation solutions, such as low efficiency or high energy costs, or to at least provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a floating power generation system. The floating power generation system may comprise: a vessel, the vessel may include: a vessel frame, a hull around the vessel frame and defining fore and aft sections, and a deck supported by the vessel frame; a gas turbine on the vessel to generate electrical power from combustion of natural gas; an organic Rankine cycle (ORC) generator on the vessel to generate electrical power from heat recovery; a gas supply line on the vessel for supplying liquefied natural gas (LNG) to the gas turbine; and a power supply subsystem to receive electrical power from at least one of the gas turbine or the ORC generator and to supply power to at least one remote power sink that is away from the vessel.

In some embodiments, the vessel may be free of propulsion means. The vessel may have a recess defined in a central part of the aft section to receive a prow of a driving vessel. The fore section of the hull has an acutely angled surface to facilitate forward passage of the vessel through water. In some embodiments, the vessel may be formed as a barge.

The floating power generation system may comprise at least one LNG storage tank on the vessel. The at least one LNG storage tank may include a plurality of LNG storage tanks disposed below the deck.

The ORC generator may configured to be used for electrical power generation in addition to the gas turbine or in substitution for the gas turbine. The ORC generator may have a first electrical power generation capacity and the gas turbine may have a second electrical power generation capacity that is higher than the first electrical power generation capacity.

In some embodiments, the power supply subsystem may be configured to vary operation of the ORC generator in response to variation of load drawn by the at least one remote power sink when the gas turbine and the ORC generator are operating simultaneously to generate electrical power and when the variation of load is within the first electrical power generation capacity.

The ORC generator may comprise a radial expander. The radial expander may include variable inlet vanes that are controllable to enable adjustment of electrical power output of the ORC generator.

The gas turbine may have a power output of between about 5 MW and about 20 MW. The ORC generator may have a power output of between about 2 MW and about 6 MW.

The floating power generation system may include: at least one storage tank to receive boil-off gas from one or more LNG storage tank; and a supplementary burner to burn the boil-off gas to generate supplemental heat for operation of the ORC generator.

The floating power generation system may include a damper which, in a first position may allow the gas turbine and the ORC generator to operate together, and in a second position may allow the gas turbine and ORC generator to operate independently of each other. The ORC generator may include a fresh air firing stack.

Some embodiments relate to a power generation installation. The power generation installation may comprise: a floating pier coupled to fixed pylons and configured to move up and down with water level relative to the fixed pylons, the floating pier being positioned to allow access to the floating pier from a shoreline; at least one floating power generation system of any of the above described embodiments moored to the floating pier; and at least one floating LNG storage vessel moored to the floating pier to supply LNG to the at least one floating power generation system.

In some embodiments, the floating pier may comprise: a gangway to allow human access; at least one first bay for receiving the at least one floating power generation system, respectively; and at least one second bay for receiving the at least one floating LNG storage vessel, respectively. The at least one floating power generation system may be moored closer to the shoreline than the at least one floating LNG storage vessel.

The at least one floating power generation system may moored to the floating pier through the use of an interlocking device. The at least one floating LNG storage vessel may be moored to the floating pier through the use of an interlocking device. The interlocking device may be a mechanical mechanism for restricting movement. In some embodiments, the interlocking device may be a hydraulic pin.

### BRIEF DESCRIPTION OF DRAWINGS

One or more embodiments will now be described by way of specific example(s) with reference to the accompanying drawings, in which:

FIG. 1 is a schematic diagram of a floating power generation system;

FIG. 2 is a perspective view of a the floating power generation system of FIG. 1;

FIG. 3 is a perspective view of a floating pier of the floating power generation system;

FIG. 4a-b is a perspective view of a bulk LNG storage barge;

FIG. 5 is a schematic diagram of an interface between a gas turbine power plant and an ORC power plant;

FIG. 6 is a process schematic diagram for equipment on the LNG storage barge of FIG. 1;

FIGS. 7a-e are process schematic diagrams for equipment on the power generation barge of FIG. 1;

FIGS. 8a-8c are process schematic diagrams for equipment on the power generation barge;

FIG. 9 is a top perspective view of the power generation barge of FIG. 9;

FIG. 10 is a perspective view of the power generation barge showing the barge structure;

FIG. 11 is a top perspective view of the storage barge of FIG. 1;

FIG. 12 is a perspective view of the storage barge of FIG. 11 showing the barge structure;

FIG. 13a is a flow diagram for illustrating a process for determining a position of a damper;

FIG. 13b is a flow diagram illustrating a process for determining whether to operate a gas turbine generator or an ORC generator;

FIG. 14a-c are 11 KV main electrical power single line diagrams;

FIG. 15a-c are 415V barge electrical power single line diagrams;

FIG. 16a-c are 110 VDC power generation barge electrical power single line diagrams;

FIG. 17a-b are schematic general arrangement diagrams of a 110 VDC power supply; and

FIG. 18a-b are schematic diagrams of electrical power communications architecture.

### DESCRIPTION OF EMBODIMENTS

### General Overview of Power Generation System

The power generation system of the present disclosure has been developed to provide access to electrical power in remote locations having variable power demand at the lowest possible energy cost.

The power generation system utilises liquefied natural gas (LNG) as a fuel in accordance with expected available resources in countries such as PNG and a desire to transition away from existing diesel power generation.

Due to the high seismic and volcanic activity of countries such as PNG, any power infrastructure plan preferably incorporates a design that will mitigate the effects of earthquake and volcanic activity experienced in those countries. Traditional land based power plants provide little or no protection against these hazards.

An off-shore power generation system 100 has been developed that significantly reduces fuel handling and LNG logistics costs in comparison to a land based power generation system whilst mitigating potential damage caused by earthquake activity and minimizing any environmental impact. The floating power generation system 100 can be relocated to meet fluctuating localized power demand as necessary such that LNG storage, regasification and power generation assets do not languish unused once industrial activity ceases in any one region. The power generation system 100 is permitted to move in the water whilst being fixed in position and utilises the benefit of the natural dampening effects of the ocean to reduce the possibility of damage caused by an earthquake. The plant equipment may be readily moved away from any volcanic event.

The LNG used to fuel the floating power generation system 100 may be initially stored at a bulk storage facility. The bulk storage facility may be up to 800 KM to 1000 KM away from the site of a power generation system 100.

The power generation system 100 includes an LNG storage barge 120, a power generation barge 110 and a floating pier 130 to which the LNG storage barge 120 and the power generation barge 110 are moored during operation of the power generation system 100. The power generation barge 110 is designed to minimise barge draught so as to allow the barge to be placed in protected harbours and as near as possible to the shore. This design permits the use of overhead power lines to connect to onshore transmission and distribution systems

The LNG storage barge 120 is an unpowered barge housing LNG storage tanks sufficient to store a minimum fuel supply, e.g. a thirty day supply of LNG, and associated Boil Off Gas (BOG) collectors. The LNG storage barge is transported between a bulk LNG storage facility 400 at which it takes on fuel and the site of the floating power generation system 100 using an Articulating Tug Boat (ATB). The ATB utilizes a hydraulic interlocking method that mates the ATB with the barge to be pushed. ATBs typically travel at 50% greater speeds than towed tugs, can operate in high seas and consume approximately 25% less fuel in comparison with a towed tug boat. The ATBs may also be operated using LNG from the LNG storage barge when in transport to avoid the use of diesel fuel. Decoupling the propulsion means from the LNG storage barge 120 removes the risk of propulsion maintenance issues that could jeopardize the reliability of the LNG supply to the remote power generation system 100. It has the additional benefit that an unpowered barge requires significantly fewer crew members than does a powered barge.

The power generation barge 110 is a single platform and a self-contained power plant with a power generation capacity in the range of 5-20 MW, for example. This level of power generation capacity is relatively small scale and appropriate for providing power to decentralized smaller communities. The power generation barge 110 is capable of operating without external fuel supply for a minimum number of days e.g. seven days. For this purpose, the power generation barge 110 includes two LNG tanks, one located at a port side and one at a starboard side of the barge. The LNG tanks may be type C cryogenic tanks, for example. The LNG tanks may be configured as pressurised tanks to allow sufficient time to transport the LNG to a desired site over a number of days without having over-pressurisation issues. This arrangement means that LNG need only be transferred periodically (e.g. every seven days) between the LNG storage barge and the power generation barge and the transfer can take place during favourable weather and sea conditions. Furthermore, the LNG storage barge may be pumped completely empty before returning to the bulk storage facility for refilling as a supply of LNG is housed on board the power generation barge. Equipment for regasification, vaporizers, LNG storage, BOG tanks and high pressure LNG liquid transfer pumps may be duplicated on each of port and starboard sides of the power generation barge to provide redundancy and ensure power plant reliability in the event of failure of any one piece of equipment.

The power generation barge 110 utilises gas turbine (GT) generators 112 for the generation of electrical power due in part to their reliability and lower maintenance requirements when compared with a reciprocating engine. The main consumables of a gas turbine generator are inlet air, lubrication oil and fuel filters and as such are a lesser requirement that the main consumables of a reciprocating engine which include large volumes of lubricating oil. As the power generation barge 110 may be located remotely from supplies of such consumables, the use of a gas turbine generator 112 therefore reduces delivery trips and waste material.

The power generation barge 110 also includes an Organic Rankine Cycle (ORC) generator 114 that generates electrical power from heat recovery. The gas turbine generator 112 can be operated alone in simple cycle or in a combined cycle together with the ORC generator 114 to produce a combined cycle efficiency that reduces the levelled cost of energy (LCOE) (the average price per unit of output needed for the plant to break even over its operating lifetime) by up to 60% when compared with simple cycle operation of the gas turbine generator 112. Operating the gas turbine generator 112 and the ORC generator 114 together in combined cycle increases power generation efficiency by about 23% in comparison with a natural gas fuelled power generator. The increase in power generation efficiency has the additional benefit of reducing NOX emissions by approximately 25%/Kwh.

ORC generators are commonly known for use in recovering low grade heat in geothermal applications. Heat Recovery Steam Generators (HRSG) are normally used in power plant applications and are significantly less expensive. However, the present power generation system 100 utilises an ORC generator 114 as it is based off-shore with no access to the significant volumes of fresh water required to operate a HRSG. Furthermore, a HRSG requires consumables in the form of chemicals for water treatment and is an open circuit rejecting heat to the environment. In contrast, an ORC generator is a closed circuit requiring no consumables, minimizing weight and energy consumption.

The ORC generator 114 of the power generation system 100 operates using a thermal fluid as a working fluid. The power generation barge 110 includes a Waste Heat Recovery Unit (WHRU) 516 in which the thermal fluid is vaporised by high temperature (500-600° C.) exhaust gases emitted from the gas turbine, supplemented by Boil Off Gas (BOG) which is flared in a supplementary firing burner. The resulting high pressure vapour is allowed to expand in a turbine that is operably associated with the generator. The expanding vapour drives the generator then is condensed using a seawater/glycol heat exchanger before being pumped back to the WHRU 516 in a closed loop.

The ORC generator 114 can be operated separately from the gas turbine 112 as a self-contained generator. This is made possible with the addition of a fresh air firing stack and burner and the application of a diverter damper positioned between the gas turbine generator and the fresh air firing stack/burner. The diverter damper can be positioned to operate the gas turbine generator 112 and the ORC generator 114 to operate together in combined cycle, or independently. This arrangement provides a degree of redundancy in the power generation capacity of the power generation system 100 and also allows the generators to be operated to maximise their efficiency during low load periods.

The power generation system 100 includes a closed loop thermal circuit to capture and exploit the latent energy released during regasification of LNG to improve the system efficiency. The latent energy is contained in the fuel when it is converted into a liquid state and amounts to approximately 10% of the BTU (British Thermal Unit) content of the fuel itself. Its capture and exploitation in the thermal circuit increases the power generation capacity and reduces parasitic load losses, thus improving the overall efficiency of the power generation system 100.

The power generation system 100 makes use of the unlimited supply of approximately 25° C. sea water off the shore of PNG in the regasification and vaporizing of the LNG. Utilizing a liquid-to-liquid vaporizer allows for the transfer of the latent energy into the closed loop thermal circuit, which provides the medium for converting the latent energy into useful work.

The thermal fluid circuit utilises the latent energy to cool inlet air being supplied to the gas turbine generator 112 from an average ambient temperature of 26° C. to 15° C., which has the effect of increasing the output of the gas turbine generator 112 by approximately 10% and improving fuel efficiency by about 3%. Once a portion of the latent energy in the thermal fluid is used for cooling the inlet air, it is then used to provide cooling for power generation barge equipment including air conditioning, turbine lube oil cooling and a liquid cooled air compressor, reducing parasitic loads and further increasing overall system efficiency.

Boil-off gas (BOG) is continuously created during the transportation, storage and handling of LNG, which must be kept at a temperature of at or below −161° C. to maintain its liquid state. The LNG warms as it contacts the walls of the storage tanks and evaporates to produce the BOG. Common practice in large scale LNG fuelled power generation plants is to compress the BOG, re-liquefy it and then immediately vaporise it for injection into the gas turbine. However, the requirement for BOG compressors and the high parasitic loads associated with them reduce overall plant efficiency. An alternative to this arrangement is to flare the BOG to atmosphere in order to control the storage tank pressure, however to do so would create a fuel loss of approximately 10%.

The present power generation system 100 utilises the BOG in the operation of the ORC generator 114 as fuel for the supplementary burner. As discussed above, the BOG is flared in the exhaust stream of the gas turbine/fresh air firing stack at the supplementary burner ahead of the WHRU 516, to capture the BOG energy in the ORC generator without the need for costly compressors or a significant increase in parasitic load.

### SPECIFIC DESCRIPTION OF EMBODIMENTS

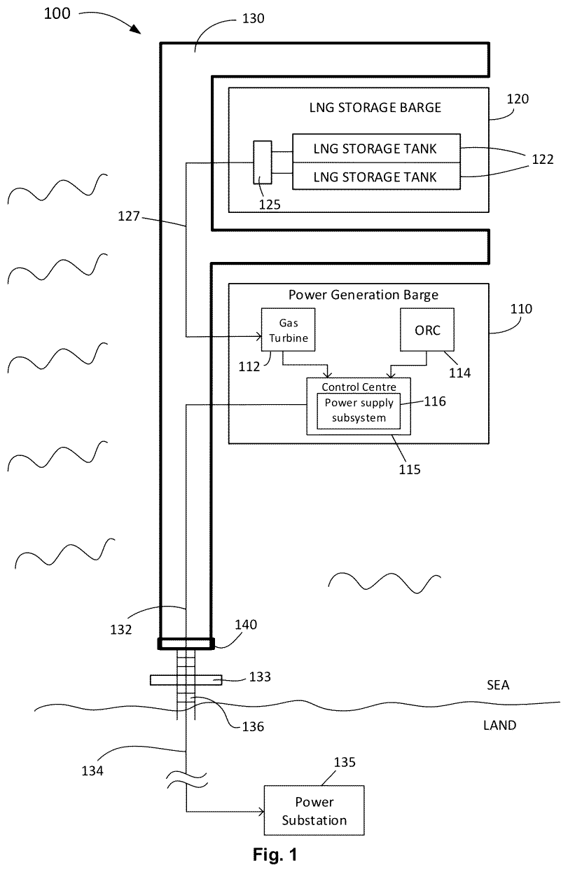

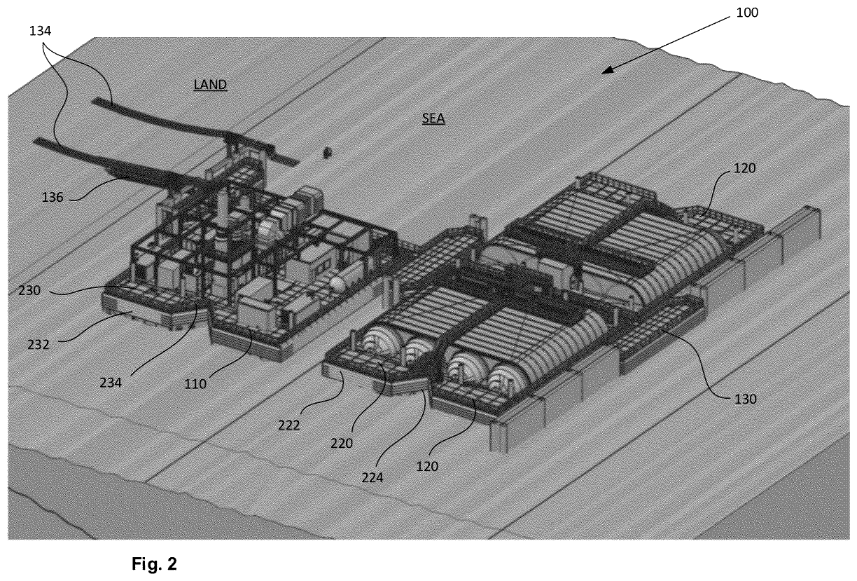

FIGS. 1 and 2 show a general arrangement of a power generation system 100 in accordance with some embodiments. FIG. 1 shows the main components of the power generation system 100 in schematic form whilst FIG. 2 is a pictorial layout of the power generation system 100. The power generation system 100 is shown installed in the sea immediately off shore of a land based power substation 135.

The power generation system 100 comprises of the power generation barge 110, the LNG storage barge 120, and the floating pier 130 to which the LNG storage barge 120 and the power generation barge 110 can be moored during operation of the power generation system.

The LNG storage barge 120 comprises of a floating vessel having a generally rectangular planform. The vessel includes a frame 220 and a hull 222 surrounding the frame 220. The frame supports a plurality of LNG storage tanks 122 and a manifold system 125. The manifold system 125 is configured to facilitate the transfer of LNG from one or both storage tanks 122 to the gas turbine 112 via supply conduit 127. The manifold system 125 may include conduits, valves, manifolds, flow control components, displays and sensors, such as pressure and flow sensors, for example. The LNG storage capacity of the LNG storage barge 120 is approximately 3000 m³, which provides a thirty day supply for the power barge 110 In the schematic embodiment shown in FIG. 1, the LNG storage barge 120 has two LNG storage tanks 122 supported thereon, each having a storage capacity of about 1500 m³. In FIG. 2, four LNG storage tanks 122 are shown, each having a storage capacity of about 750 m³. The number of LNG storage tanks 122 on the barge 120 can vary as long as the storage capacity is sufficient to store a minimum fuel supply, e.g. enough to operate the gas turbine 112 for thirty days. This amount of stored fuel ensures that the LNG storage barge 120 needs to return to a bulk storage facility 400, which may be hundreds of kilometres away from the power generation system site, only once every thirty days. Providing storage capacity for a thirty day supply of LNG allows for sufficient redundancy in the delivery schedule if weather or ocean conditions prevent LNG shipments. LNG in the storage tanks 122 is supplied to the power generation barge via an LNG supply conduit 127.

The vessel frame 220 and hull 222 of the LNG storage barge 120 define a barge having a broad and shallow draught suitable for mooring in shallow water. The hull 222 defines fore and aft sections of the barge. A deck 1110 (see FIG. 11) is supported by the vessel frame 220 for ease of operational and maintenance access. The LNG storage barge 120 does not have its own in-built propulsion means. Instead, the hull 222 has a recess 224 defined in a central part of the aft section to receive the prow of a driving vessel, for example an articulated tug boat (ATB) (not shown). The recess 224 is shaped with an apex having an acute angle that is sufficiently large to receive the prow of the driving vessel and to allow it to drive the LNG storage barge 120 by pushing it forwards. The recess 224 includes one part of a two-part interlocking mechanism (not shown) for locking the LNG storage barge 120 to the ATB. The ATB includes the second part of the two-part interlocking mechanism. For example, hydraulic pistons may be driven from the ATB into the barge 120 to mate the two vessels into a single floating unit. In one embodiment, the hydraulic interlocking mechanism is a hydraulic pin. The fore section of the hull 222 has an acutely angled surface 1140, seen in FIG. 11, that facilitates forward passage of the barge vessel through water. Decoupling the propulsion means from the LNG storage barge 120 removes the risk of propulsion maintenance issues that could jeopardize the reliability of the LNG supply to the remote power generation system 100. It has the additional benefit that an unpowered barge requires significantly fewer crew members than does a powered barge.

The power generation barge 110 is a generally rectangular shaped floating vessel having an planform area of approximately 30 m² and comprising of a vessel frame 230 supporting a main deck 930, and a below deck space 1020 beneath the main deck. A hull 232 surrounds the frame 230 and defines fore and aft sections of the power generation barge 110. The power barge 110 is a self-contained LNG storage, regasification and combined cycle power plant as will be described herein. Electrical power is generated using the gas turbine 112 and/or the ORC generator 114. The LNG supply conduit 127 supplies LNG to the power generation barge 120 where it is vaporized for use as fuel in the gas turbine 112. The ORC 114 operates using a thermal fluid as a working fluid. Waste heat from the gas turbine 112 may be utilised in providing heat energy to the thermal fluid. Both the gas turbine 112 and the ORC generator 114 generate electrical power to a power supply subsystem 116 that is controlled by a control centre 115. The control centre 115 monitors the power load demand at the land-based power substation 135 and controls the operation of the power plant accordingly.

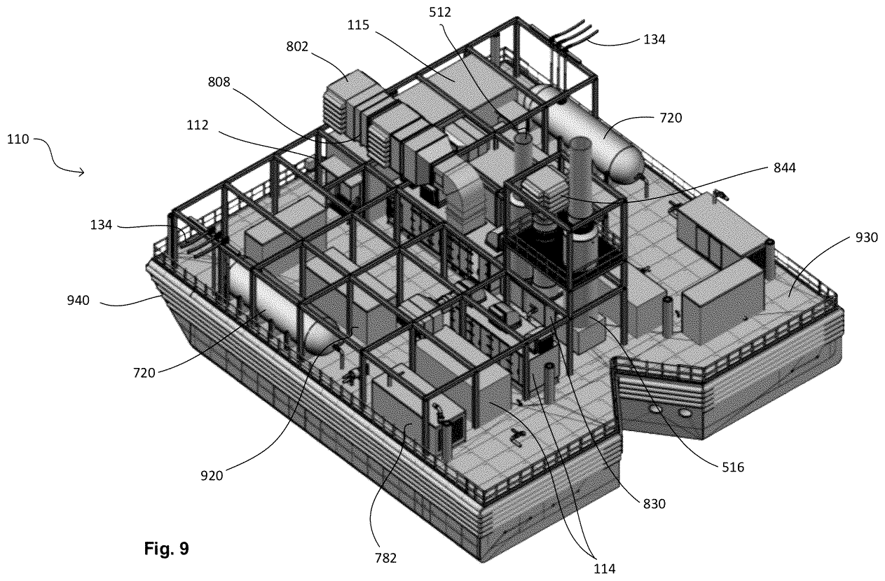

The vessel frame 230 and hull 232 of the power generation barge 110 define a barge having a broad and shallow draught suitable for mooring in shallow water. The hull 232 defines fore and aft sections of the barge. The power generation barge 110 does not have its own in-built propulsion means. Instead, the hull 232 has a recess 234 defined in a central part of the aft section to receive the prow of a driving vessel, for example an articulated tug boat (ATB) (not shown). The recess 234 is shaped with an apex having an acute angle that is sufficiently large to receive the prow of the driving vessel and to allow it to drive the power generation barge 110 by pushing it forwards. The fore section of the hull 232 has an acutely angled surface 940, seen in FIG. 9, that facilitates forward passage of the barge vessel through water. As with the LNG storage barge 120, decoupling the propulsion means from the power generation barge significantly reduces required crew numbers and avoids potential disruption to power supply due to propulsion maintenance if issues occur away from the site of the power generation system 100.

The power generation barge 110 has a shallow draught to allow the barge to be positioned in protected harbours and as near as possible to the shore. This permits the use of overhead power lines 132, 134 that are connected from the power supply subsystem 116 to the land transmission and distribution systems at the power substation 135. In some embodiments, a first power line 132 may extend from the power supply subsystem 116 to a connection apparatus 133 that is in electrical connection with a second power line 134 to provide power to power substation 135. The connection apparatus 133 may include a transformer, fused cutout and load break elbow, gang operated load break switches and/or other system for physically and/or electrically allowing connection and disconnection of the first power line 132 to and from the second power line 134. The connection apparatus 133 may be located on the floating pier 130 (e.g. at or near security gate 140), on the gangway 136 or at a secure installation on land, for example. A quick connect/disconnect system (not shown) on the power barge 110 may allow disconnection of the gas turbine 112 and the ORC generator from the first power line 132 for quick removal of the barge in the event of an emergency.

The floating pier 130 is an elongate steel structure coupled to fixed structural piles or pylons 305 that fix the position of the floating pier 130 relative to the sea floor, whilst allowing it to rise and fall with sea conditions, for example due to tidal currents. The floating pier 130 includes an elongate landward pier section 322 and an elongate seaward pier section 326. The landward pier section 322 is connected to the seaward pier section 326 by a central platform 324 that extends at right angles to the pier sections, approximately parallel to the shoreline. A seaward platform 328 extends parallel to the central platform 324 at the seaward end of the seaward pier section 326 and a landward platform 320 extends parallel to the central platform 324 at the landward end of the landward pier section 322. An LNG storage barge mooring bay 312 is defined at either side of the seaward pier section 326, between the seaward platform 328 and the central platform 324. A power generation barge mooring bay 310 is defined at either side of the landward pier section 322, between the seaward platform 328 and the central platform 324.

Each of the seaward pier section 326 and the landward pier section 322 includes an interlocking device 340 at either side thereof for use in locking the power generation barge 110 and the LNG storage barge 120 in to the mooring bays 312, 310. Interlocking the barges and the floating pier 130 in this manner reduces the degree and angle of movements possible due to tidal and wave effects at the critical LNG fluid transport conduit 127 between the LNG storage barge 120 and the power generation barge 110 and allows for LNG fuel transfers during higher wind and sea conditions. The interlocking device 340 may be a mechanical mechanism suitable for restricting movement between the floating pier 130 and the power generation barge 110 and/or the LNG storage barge 120. For example, the interlocking device 340 may be a hydraulic interlocking device, such as a hydraulic pin.

Known floating power generation systems generally use mooring/dock lines or sea anchor systems to secure a vessel to a platform/pier. These mooring/dock lines and sea anchor systems generally result in a greater degree and angle of movement of the vessel relative to the platform/pier due to wind and/or sea conditions. Reduction of this movement through use of the interlocking device 340 may allow for transfer of resources between the LNG storage barge 120 and the power generation barge 110 at times when greater wind and/or sea conditions would prevent or restrict resource transfer for the known floating power generation systems. That is, interlocking device 340 may allow the floating power generation system 100 to overcome restrictions of resource transfers, such as LNG and BOG transfers, of known floating power generations due to wind and/or sea conditions, for example. This in turn permits smaller resource transfers to be carried out intermittently, e.g. in response to demand, rather than a bulk resource transfer having to be carried out in lesser wind and/or sea conditions.

The seaward end of the floating pier 130 further includes a floating wall 335 that extends collinearly from either end of the seaward platform 328, approximately parallel to the shoreline. The floating wall 335 extends beyond the end of the LNG storage barge 120 when moored in the mooring bay 312 to provide some protection for it and the power generation barge 110 from tidal swells. At the landward end of the floating pier, a gangway 136 extends from the seaward platform 320 to the land to provide human access to the floating pier 130 from the shore.

As shown schematically in FIG. 1, a security gate 140 can be installed at the landward end of the floating pier 130. The security gate 140 provides controlled access onto the floating pier 130 and thereby onto the power generation barge 110 and the LNG storage barge 120, when those barges are moored in and interlocked with the floating pier 130. The security gate 140 includes a security door, gate or other barrier and has a controlled entry device such as a terminal requiring a pass key or similar to be presented to permit access through the door, gate or other barrier. A human passing the security gate 140 can access the length of the floating pier 130 including the landward platform 320, central platform 324 and seaward platform 328, to gain access to a moored power generation barge 110 or LNG storage barge 120.

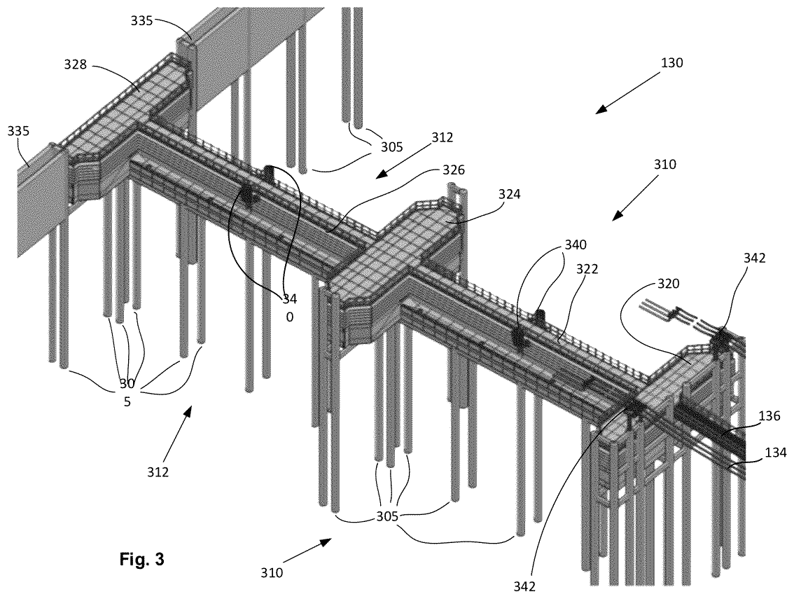

As shown partially and schematically in FIG. 3, the overhead power lines 132 from the power barge 110 extend parallel to the gangway 136 towards the shore. A support structure 342 extends vertically upwards from the landward platform 320 for supporting the first power line 132 on the seaward side of where they connect to connection apparatus 133 and/or second power line 134. Further support structures 342 for the first power line 132 may be provided at the power generation barge 110. The electrical power from power generation barge 110 may be connected via first power line 132 at 11 kV using gang operated load break switches mounted on the pile structures 305, for example. An overhead line pole on one of the piles of pile structure 305 may have a fused cutout and load break elbow mounted on the top of the pole to allow isolation and disconnection of power line 132 from the power generation barge 110.

The floating pier 130 remains at a neutral buoyancy at all times as it rises and falls with the tide. The floating pier 130 accepts power generation barges 110 of different sizes, for example a smaller electrical power capacity barge or a larger electrical power generating capacity barge, to provide for exchanging of barges and scalability of the power generation system 1. This is achieved by interchangeability of the interlocking connections 340, which can be used to interlock either a power generation barge 110 of various electrical power capacity or an LNG storage barge 120. In an optional embodiment, a spare power generation barge 110 is provided to permit exchanging of the entire power generation barge 110 during maintenance work on the gas turbine 112, thus eliminating any shutdown requirement of the power generation system 100 for that purpose.

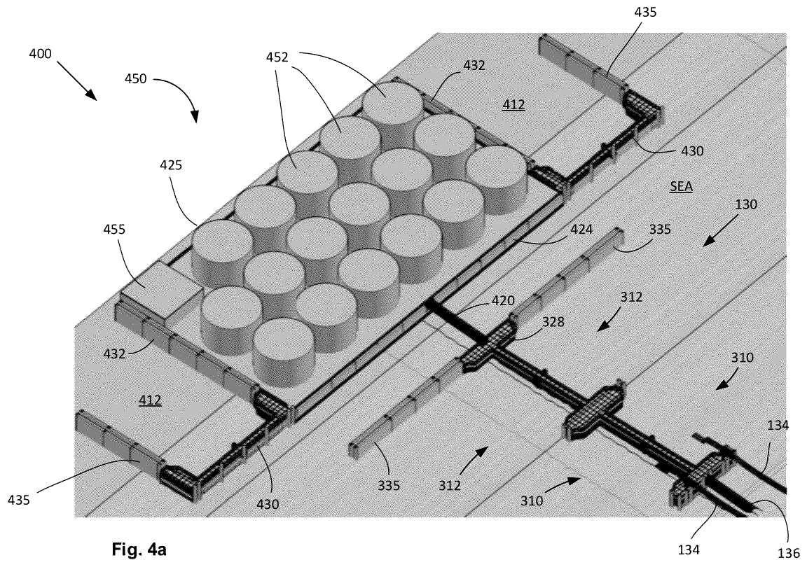

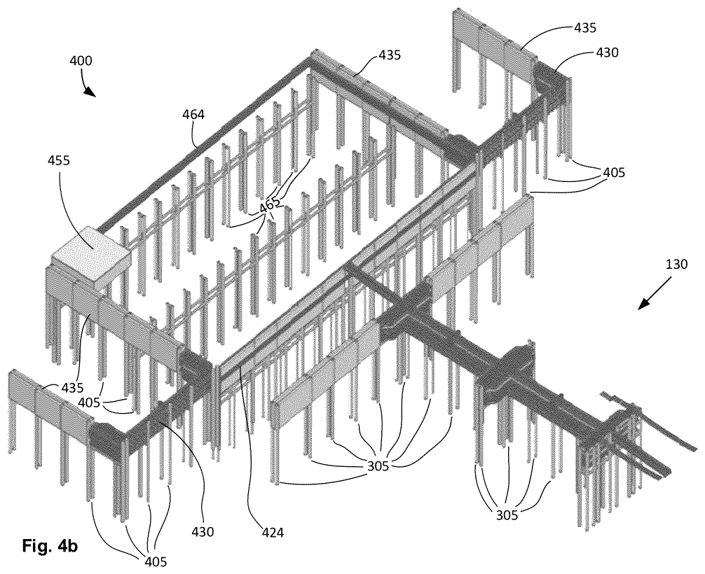

FIG. 4A and FIG. 4B show a floating pier 130 installed adjacent a bulk storage facility 400, also situated in the sea off the seaward end of the floating pier 130. The bulk storage facility 400 facilitates the storage of 40,000 m³ of LNG in multiple storage tanks 452. The bulk storage facility 40 is necessary to provide a refuelling station for the smaller 3,000 m³ LNG storage barges 120 and bulk storage facilities 40 are located at hub sites that can be reached by LNG storage barges 120 by sea. The bulk storage facilities 400 reduce shipping times to remote power generation system sites. For example, the bulk storage facility 400 is positioned at a distance of 800-1000 Km from multiple remote power generation systems 100, resulting in a return LNG delivery cycle from the bulk storage facility 400 to a power generation system 100 of approximately 9 days by sea. The bulk storage facility 400 can also supply larger volumes of LNG that are necessary to supply multiple larger generators at remote site locations where power demand is greatest.

The bulk storage facility 400 is a floating structure having a platform 450 supported by fixed structural piles or pylons 405, 465 (seen in FIG. 4B) that fix the position of the bulk storage facility 400 relative to the sea floor, whilst allowing it to rise and fall with tidal currents. The platform 450 supports the multiple storage tanks 452 thereon. In the example of FIG. 4A, the platform supports 17 storage tanks 452, however the number of tanks may vary according to specific storage capacity requirements at a particular site. The bulk storage facility 400 is positioned offshore from the floating pier 130 and assists in providing protection for the power generation system 100 in high seas.

The platform 450 is rectangular in planform and has two longer sides including a landward facing side 424, a seaward facing side 425 and two shorter side walls 432. The platform 450 consists of a supporting perimeter frame 464 to which the walls 424, 425, 432 are attached. A landward facing side 424 of the platform 450 extends the length of and parallel to the seaward platform 328 and the seawalls 335 of the floating pier 130. A gangway 420 extends between the platform 450 and the seaward platform 328 of the floating pier 130 for providing human access to the bulk storage facility 400. A pair of mooring bays 412 is defined, one at either side of the platform 450, by the sidewalls 432, an access pier 430 that extends into the sea from and collinear with the landward facing wall 424 of the platform, and a seawall 435 positioned at a distal end of the access pier 430 and which extends parallel to the sidewall 432. The sidewall 432, access platform 430 and seawall 435 form a U-shaped barrier in the sea to define the mooring bay 412 into which a refuelling LNG storage barge 120 can be moored. The access pier 430 provides human access from the platform 450 to the LNG storage barge 120 when it is moored in the mooring bay 412. A facility management control system in control room 455 on the platform 450 controls the operation of the bulk storage facility 400, including monitoring storage tank 452 levels and conducting LNG supply operations to storage tanks 122 on a moored LNG storage barge 120. The facility management control system includes a dedicated control panel for each system or subsystem. For example, the gas turbine (GT) system and ORC 114 each have a dedicated control panel to allow operator monitoring and control. Further, the facility management control system integrates the operation of the GT, the ORC, fuel transfer, heat exchange fluid systems and ballast systems (which need to be adjusted as fuel as consumed). the facility management control system further monitors fuel levels in the fuel barge and controls fuel transfers using fluid transfer infrastructure (e.g. pumps, valves, conduits) in system 100 as required.

Fluid transport conduits (not seen in Figs) are provided for the purpose of refuelling the LNG storage barges 120 from the storage tanks 452. A system of valves (not seen in Figs) is provided to control the supply of LNG in the fluid transport conduits.

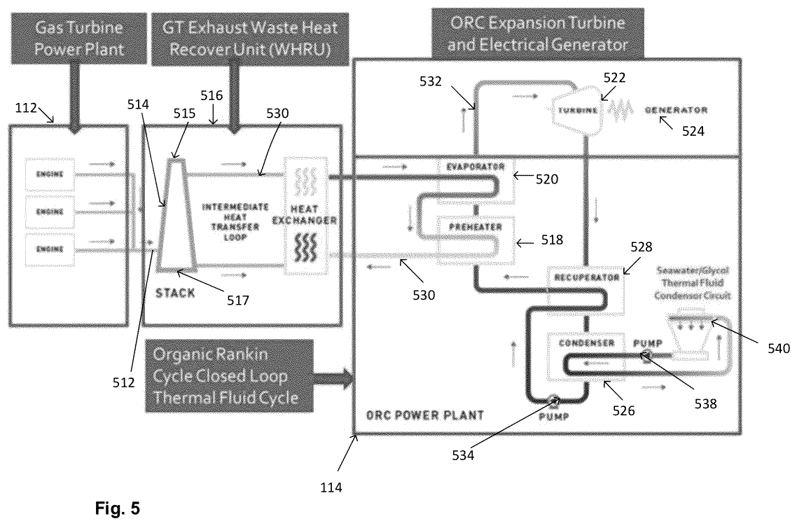

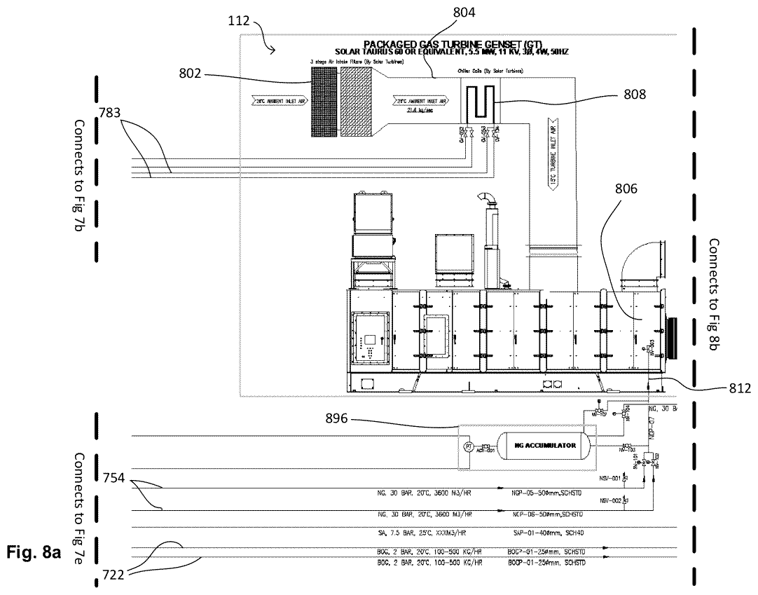

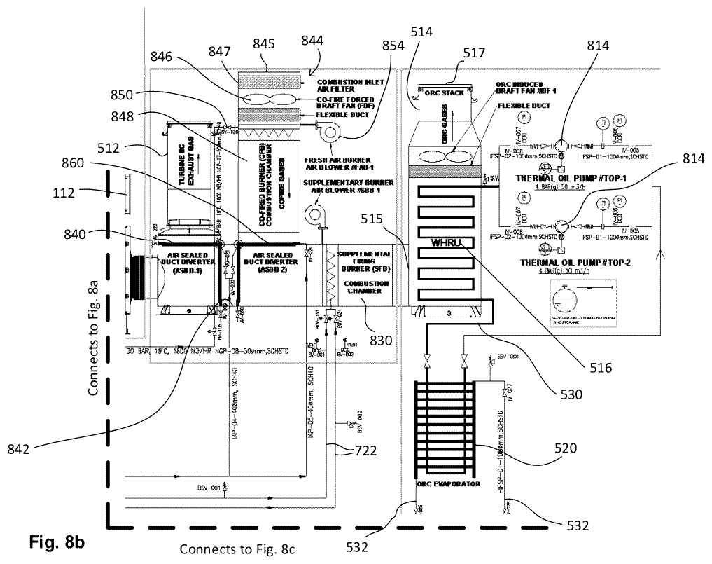

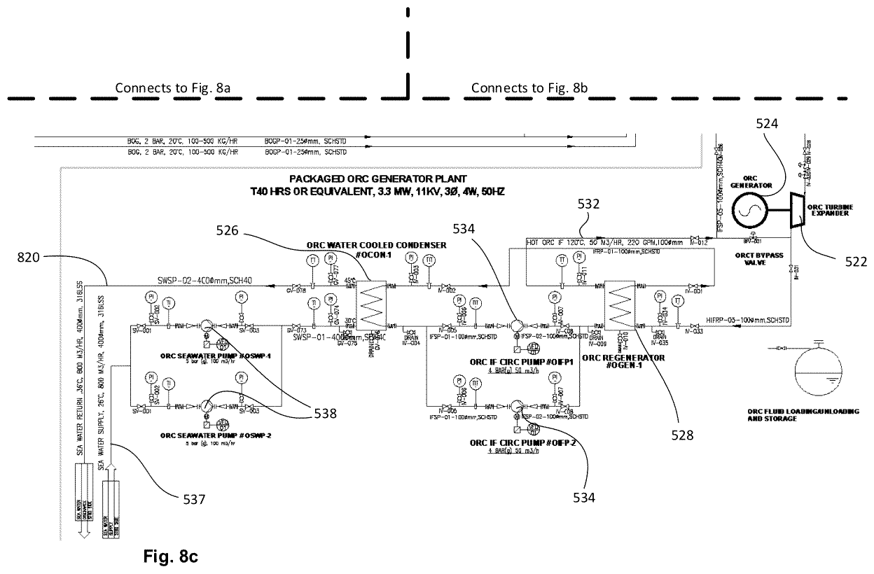

Turning now to the operation of the power generation system 100, FIG. 5 is a schematic diagram that illustrates the interface between the gas turbine power plant 112 and the ORC 114 as well as the main components of the ORC 114. The equipment and fluid connections for the gas turbine 112 and the ORC 114 are shown in more detail in FIG. 8. The gas turbine power plant 112 comprises one or more marinized versions of natural gas turbines, for example the 5.3 MW Solar Taurus 60 turbine (at ISO conditions), or the 15.6 MW Solar Titan 130 turbine (at ISO conditions), manufactured by Solar Turbines™. The marinized versions of these turbines are adapted for marine environments, for example by employing stainless steel enclosures and critical components. The gas turbine generator 112 is also provided with thrust bearings and three-point mounting systems to allow for deflection and movements of the power generation barge 110. The electrical power capacity of the gas turbines is selected for the intended use of the power plant. In the present example, the 5.3 MW and 15.6 MW gas turbines are appropriate for smaller plant ratings such as are required for use in remote areas such as PNG. It will be appreciated that any suitable gas turbine can be used that is appropriate for the intended use. A gas turbine generator requires a periodic maintenance overhaul. In an embodiment of the power generation system 100, an additional power generation barge 110 is provided such that during periods of maintenance, the power generation barge 110 can be exchanged with the replacement barge without causing an appreciable interruption in power supply to power substation 135.

The gas turbines 112 each include a generator for the generation of electrical power from shaft work. In the schematic diagram of FIG. 5, the gas turbine power plant 112 includes three gas turbine generators 112 which may be of the same or different electrical power capacity. However, the power generation system 100 may have only a single gas turbine generator 112 or multiple gas turbine generators 112 according to the specific design of the power barge 110. The following description assumes a single gas turbine generator 112 for clarity.

The gas turbine 112 has an exhaust conduit 512 through which the exhaust gases pass following the passing of the combustion gases through the engine turbine. The exhaust gases are typically at a temperature of 500-600° C. The exhaust conduit 512 is arranged in fluid communication with an ORC stack 514 at a lower end 515 thereof and rise to the top of the ORC stack 514 where they exit at an upper end 517 to the ambient atmosphere.

As seen in FIG. 5, the ORC stack 514 is integrated into the Waste Heat Recovery Unit (WHRU) 516. The WHRU 516 provides an interface between the gas turbine 112 and the ORC 114. The ORC power plant 114 is of itself an independently operable electrical power generator, however process efficiencies arise when it is operated in combination with the gas turbine power plant 112 as will be described herein.

The evaporator 520 and, optionally, the pre-heater 518 form part of the WHRU 516 so as to recover heat from the exhaust gases in the ORC stack 514 to heat the thermal fluid of the ORC 114. The WHRU 516 is essentially a heat exchanger that utilises a thermal oil closed loop circuit that passes through the ORC stack 514 and the evaporator 520 of the ORC 114. The thermal oil circuit includes a thermal oil conduit 520 and a pump 814, seen in FIG. 8b. The thermal oil conduit 530 passes through the upper end 517 of the ORC stack 514 and exits the stack 514 at its lower end 515. The thermal oil conduit 530 then continues to the evaporator 520. In FIG. 5, the conduit 530 also passes through the preheater 518, however this is optional. Upon exiting the evaporator 520 or, if utilised, the preheater 518, the conduit 530 returns to the upper end 517 of the stack 514.

The thermal fluid in the conduit 530 is pumped into the upper end of the ORC stack 530 by the pump 814 and is heated by the exhaust gases flowing upwardly through the ORC stack 514. The heated thermal oil exits the lower end 515 of the ORC stack 514 and passes through the evaporator 520 where its heat energy is transferred to the working fluid of the ORC passing through the evaporator 520. The thermal oil is therefore cooled as it exits the evaporator 520. If the thermal oil also flows through the preheater 518 it transfers further heat energy to the ORC working fluid prior to the entry of the working fluid into the evaporator 520.

The cooled thermal oil is then pumped back into the ORC stack 514. The exhaust gases are cooled from 500 degrees C. to about 130 degrees C. in the ORC stack 514, the waste heat energy being transferred to the ORC working fluid and utilised for the generation of electrical power at the ORC 114. Cooling of the exhaust gases in the ORC stack 514 may reduce the parasitic load of the ORC 114. Cooling of the exhaust gases in the ORC stack 514 may improve overall efficiency of the floating power generation system 100.

The ORC 114 operates in a standard ORC closed loop. The cycle includes a pre-heater 518, evaporator 520, expansion turbine 522, electrical power generator 524, condenser 526 and a recuperator 528, through which the thermal fluid passes during the cycle. The ORC working fluid is a thermal fluid that is transported through the cycle in a thermal fluid conduit 532. A pump 534 positioned in the conduit 532 between the condenser 526 and the recuperator 528 is utilised to pump low pressure, low temperature thermal fluid exiting the condenser 526 through the conduit 532 and into the recuperator 528. The thermal fluid recovers heat and pressure then passes through the preheater 518 and the evaporator 520 where heat is transferred from the very hot thermal oil in the thermal oil conduit 530 of the WHRU 516, and evaporated to a vapour at high temperature and pressure.

The turbine 522 may be a radial turbine, for example an Atlas Copco radial turbine, or it may be an axial turbine, for example a Turboden axial turbine. Where the turbine 522 is a radial turbine, it has variable inlet vanes that are controllable to enable adjustment of electrical power output of the ORC generator 114. For example, if a rapid drop or spike in voltage is detected at the control room 910 of the ORC generator 114, an automatic pneumatic control associated with the turbine 522 opens or closes the vanes to an extent to increase or decrease the flow of thermal fluid passing there through. Where the turbine 522 is an axial turbine, an automatic controller associated with the turbine 522 opens and closes a valve in the thermal fluid conduit 532 to increase or decrease the flow of thermal fluid passing through the turbine 522. The vaporised high pressure thermal fluid exiting the evaporator flows quickly through the turbine 522 to cause rotation of the turbine shaft to generate work. The rotating shaft drives the electrical power generator 524 for the generation of electrical power to the power supply subsystem 116.

The thermal fluid is expanded in the turbine 522 and its pressure and temperature reduced. The cooled vapour passes through the recuperator 528 where it is utilised to transfer heat to the condensed thermal fluid passing through the recuperator in the opposite direction having exited the condenser 526 as described above, further cooling the vapour. The cooled vapour thermal fluid exiting the recuperator 528 is then condensed into liquid form in the condenser 526 and the cycle begins again.

The condenser 526 forms part of a separate sea-water circuit 536. The sea-water circuit supplies seawater into a seawater conduit 537 at about 26° C. A seawater pump 538 in the seawater conduit 537 is arranged for pumping the seawater into the condenser 526 to cool the thermal fluid vapour in order to condense it. The warmed seawater exits the condenser and is returned into a discharge conduit 820, seen in FIG. 8c at a temperature of about 36° C.

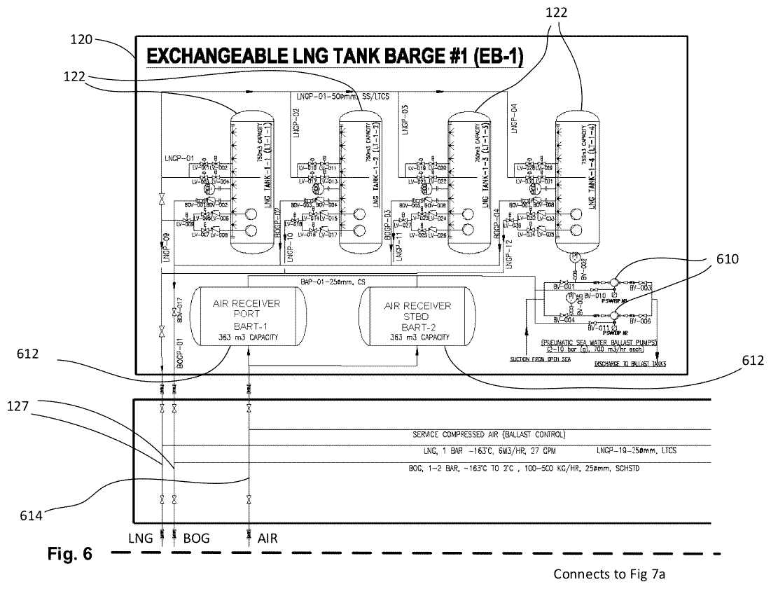

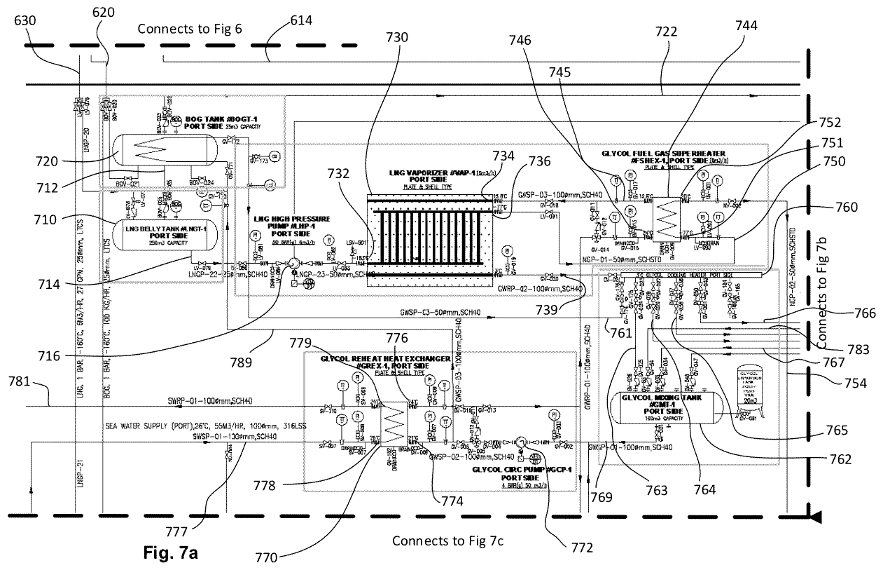

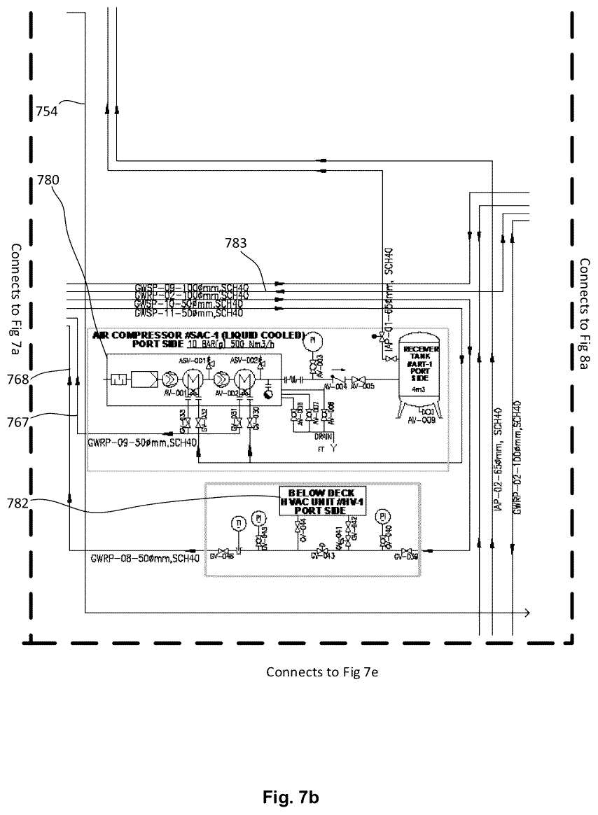

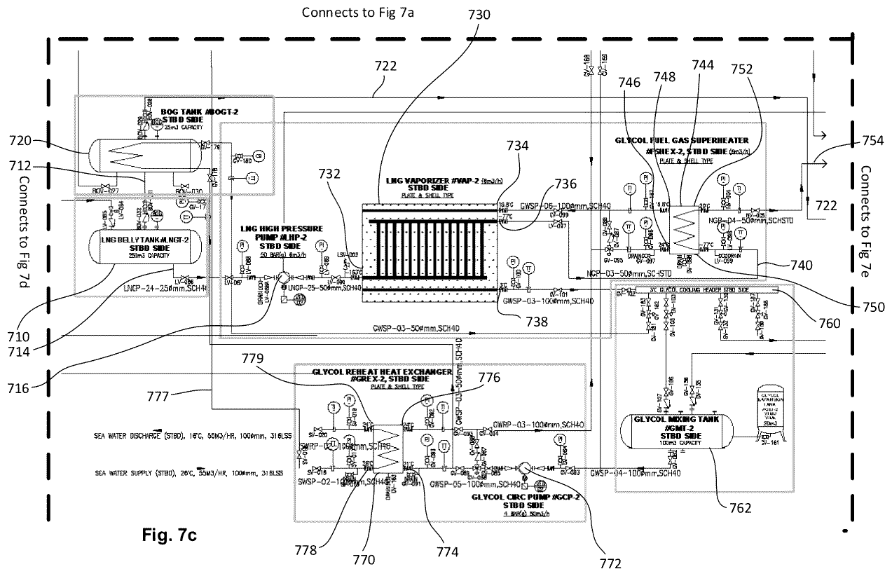

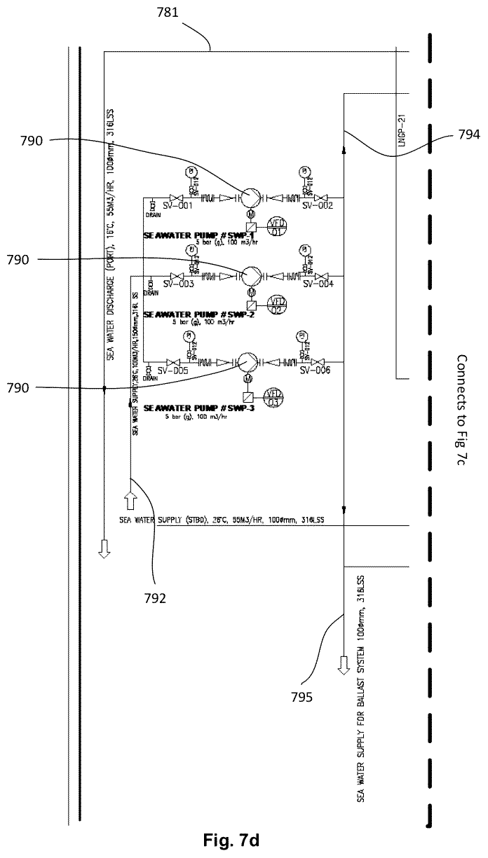

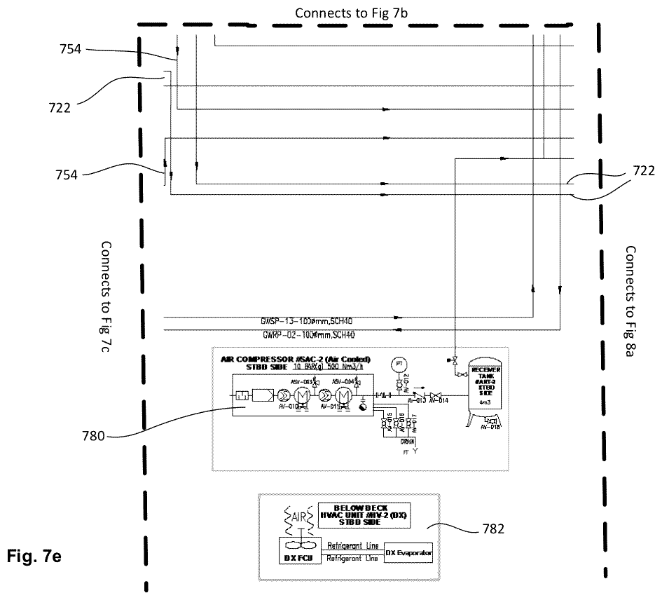

FIGS. 6 to 8c are process and equipment diagrams for the LNG storage barge 120 (FIG. 6) and the power generation barge 110 (FIGS. 7-8c). LNG is initially stored on the LNG storage barge 120 and is then transferred from the storage barge 120 to the power barge 110. FIGS. 7-8c each show a portion of the power barge process, which process may continue in another diagram. Accordingly, each of FIGS. 6-8c states where it connects to one of the other Figures for clarity. There may be a small overlap between some of the Figures as will be apparent when two connected Figures are viewed together.

The LNG storage barge 120 is arranged in port and starboard layout, with the starboard half of the LNG storage barge 120 being a mirror image of the port half. This deliberate duplication of equipment provides redundancy to the storage barge 120 and to ensure that a supply of LNG is present in the event of any equipment failure on either half of the storage barge 120. FIG. 6 shows the port half of the storage barge 120, it being understood by the skilled person that the starboard half is identical in terms of equipment and differs only in the placing of pipelines/conduits. Each half of the storage barge 120 houses four LNG storage tanks 122. The LNG storage tanks 122 have a collective volumetric capacity of between 1000 m³ and about 6000 m³. In the present embodiment, the four LNG storage tanks 122 have a collective volumetric capacity of about 3000 m³, however this capacity may be provided by two or three tanks rather than four. Each LNG storage tank 122 has a fluid transport conduit 623 for the supply of LNG into the tanks 122. A valve system 624 in the fluid transport conduit 623 at each tank 122 is operable to control the flow of LNG in the fluid transport conduits 623 and into the LNG storage tanks 122. Further fluid transport conduits 625 allow LNG to flow out of the LNG storage tanks 122 and into the LNG supply conduit 127. The valve system 624 includes valves in the fluid transport conduits 625 to control the flow of LNG out of the tanks 122 and into the fluid transport conduits 625.

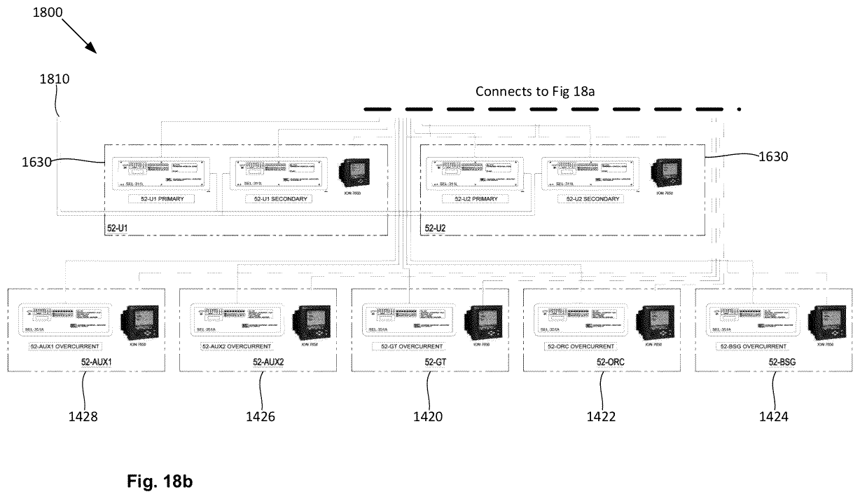

The storage barge 120 further includes a Boil Off Gas (BOG) exhaust conduit 630 for receiving and transporting boil off gas produced by the LNG in the LNG storage tanks 122. The boil off gas may be transported to the power barge 110 via the BOG exhaust conduit 630. The storage barge 120 further includes one or more compressed air tanks 612 for the supply of compressed air for the operation of one or more ballast pumps 610 and/or one or more high pressure pumps 716. The ballast pumps 610 draw in sea water into ballast tanks located within the hull 222 for ballast control as the stores of LNG are depleted. A compressed air supply line 614 for supplying compressed air to the compressed air tanks 612 is arranged in fluid communication with one or more air compressors 780 situated on the power generation barge 110, seen in FIGS. 7b and 7e. Situating the one or more air compressors 780 on the power generation barge 110 avoids the requirement for an ignition source for the air compressor(s) 780 being located on the storage barge 120. A pump control interface at the ballast pumps 610 allows control of the ballast pumps 610 and/or the one or more high pressure pumps 716 by an external controller in the control centre 115, such as a control room computing device 1815 (FIG. 18a). An external control line is coupled to the pump control interface for this purpose.

The LNG supply conduit 127 supplies LNG at −160 degrees C., 1 bar, to the power generation barge 110. The boil off gas (BOG) exhaust conduit 630 transports boil off gas from tanks on each barge at −160 degrees C., 1 bar, to the power generation barge 110.

The LNG supply conduit 127 and the BOG exhaust conduit 630 extend to the power generation barge 110 shown in FIGS. 7a-7e and FIGS. 9 and 10. The power generation barge 110 has power generation equipment arranged on both a port side 711a and a starboard side 711b for even distribution of weight on the barge. Some equipment is duplicated on the port and starboard sides of the power generation barge 110 to provide essential redundancy of plant equipment to ensure continuity of power supply in the event of equipment failure.

LNG is supplied to LNG belly tanks 710 at each of the port side 711a and starboard side 711b of the barge. The belly tanks 710 are installed on the upper deck of the power barge 110 and each has a capacity of 250 m³ which is sufficient to provide enough fuel for the gas turbine power plant 112 to last around 7 days. A single, larger LNG tank has benefits over several smaller tanks in simpler refuelling logistics. Furthermore, a single well-insulated tank produces significantly less BOG than would several smaller tanks, due to a smaller tank surface area in contact with the LNG. Each belly tank 710 is fluidly connected via a pipeline 712 to a BOG tank 720 for the storage of BOG evaporating from LNG stored in the belly tank 710. The BOG tank 720 has a capacity of 25 m³. A further pipeline 722 is provided between the BOG tank 720 and a supplemental firing burner 830 of the power barge 110, seen in FIG. 8b, to provide fuel for the supplemental firing burner 830.

The port side LNG belly tank 710 is fluidly connected via an LNG supply conduit 714 to a vaporizer 730. The vaporizer 730 is a plate and shell type heat exchanger that takes in LNG at −163° C. at a ‘cold’ side thereof and a thermal fluid at 15.8° C. at a ‘hot’ side thereof. A high pressure pump 716 is located in the LNG supply conduit 714 for pumping LNG in the conduit 714 into the vaporizer 730. In some embodiments, the high pressure pump 716 is a pneumatic pump. High pressure pump 716 may be a pneumatic submersible cryogenic transfer pump, for example. Using a pneumatic pump may reduce the risk of ignition of flammable materials, such as LNG, on-board the storage barge 120.

The thermal fluid, which in the present embodiment is glycol, is introduced into a ‘hot’ inlet 734 of the vaporizer 730 at 15.8° C. The plate and shell vaporizer 730 facilitates heat transfer between the two fluids as they pass through the vaporizer 730 such that the LNG vaporises to natural gas as it passes through and exits the vaporizer 730 at a ‘cold’ exit 736 at −77° C. The thermal fluid exits the vaporizer 730 at a ‘hot’ exit 738 at a temperature of 3° C.

The natural gas exits the vaporizer 730 into a natural gas conduit 750 for transportation to a natural gas/thermal fluid superheater 744. The superheater 744 is a further plate and shell type heat exchanger that utilises heat energy stored in the thermal fluid before it enters the vaporizer 730, to transfer further heat energy to the natural gas in the superheater 744. The thermal fluid is supplied to the superheater 744 at a ‘hot’ inlet 746 at a temperature of 24° C. and exits the superheater 744 at a ‘hot’ exit at a temperature of 15.8° C., the temperature at which it enters the vaporizer 730. The natural gas is supplied to the superheater 744 at a ‘cold’ inlet 751 at a temperature of −77° C., the temperature at which it exited the vaporizer 730. It is warmed by heat exchange with the thermal fluid and exits the superheater 744 at a ‘cold’ exit 752 of the superheater into a transportation conduit 754 for transportation to the gas turbine power plant 112 for burning as fuel. That is, the thermal fluid has a working temperature of between about 3° C. and about 24° C., for example.

The thermal fluid passes through the vaporizer 730 and the superheater 744 as part of a closed loop thermal fluid circuit that will be described next. The thermal fluid circuit recovers latent energy released when the LNG is converted to its vapour state in the vaporizer 730 and transfers it to the thermal fluid in the thermal fluid circuit. The latent energy is then utilised at several points in the thermal fluid circuit to improve the efficiency or power output of the power barge. As shown in FIG. 7a, the thermal fluid circuit includes the superheater 744, the vaporizer 730, a cooling header manifold 760, a mixing tank 762 and a glycol/sea-water heat exchanger 770. As described above, the thermal fluid passes through the superheater 744 and into a conduit 745 from which it passes through the vaporizer 730 and is cooled to 3° C. From here, the thermal fluid passes through a further conduit 739 to the cooling header manifold 760. The cooling header manifold 760 also receives thermal fluid in a conduit 761 that has passed through the BOG tank 720 to cool the glycol to a temperature within a target cooled temperature range before it enters the cooling header manifold 760. The temperature of the cooled glycol will depend on ambient temperature and how much boil-off is produced as a result, although lower temperatures are preferred. The closed loop thermal fluid circuit helps to control the boil-off gas (BOG) pressure in the tank. The glycol will be much hotter than the boil-off gas so this will increase the pressure in the BOG tank to assist in raising it to the pressure needed for the supplemental burner. That is, the glycol is used to heat the BOG such that the pressure of the BOG increases prior to entering the supplementary burner. As a result, the temperature of the BOG is also increased due to thermal transfer of heat from the glycol.

The thermal fluid supply is divided into streams at the cooling header manifold 760 for transportation to other parts of the power barge 110. The fluid conduit 763 transports the thermal fluid from the cooling header manifold 760 to the mixing tank 762. The fluid conduit 764 transports the thermal fluid from the cooling header manifold 760 to a port side air compressor 780 (see FIG. 7b) where the thermal fluid is used to cool the air compressor 780. The thermal fluid is then returned to the mixing tank 762 via a fluid conduit 767. The fluid conduit 765 transports the thermal fluid from the cooling header manifold 760 to a below deck HVAC unit 782 (see FIG. 7b), where it is used to cool the HVAC unit 782. The thermal fluid is then returned to the mixing tank 762 via a fluid conduit 768. The fluid conduit 766 transports the thermal fluid from the cooling header manifold 760 for use at the gas turbine 112, notably in cooling inlet air of the gas turbine engine 112, as will be described later. In an embodiment, a portion of the thermal fluid can also be diverted for use in cooling turbine lube oil. The thermal fluid utilised at the gas turbine 112 is warmed by the turbine inlet air and/or the turbine lube oil and is returned to the mixing tank 762 via a fluid conduit 783.

The mixing tank 762 has a capacity of 100 m³ and mixes and stores the thermal fluid received from the fluid conduits 763, 767, 768. The mixing tank 762 has an outlet to a fluid conduit 769 that is fluidly connected to the glycol/sea-water heat exchanger 770. The glycol thermal fluid in the thermal circuit flows from the mixing tank 762 through the fluid conduit 769 and is pumped by a glycol pump 772 into a ‘cold’ inlet 774 of the glycol/sea-water heat exchanger 770. The glycol/sea-water heat exchanger 770 is a plate and shell type heat exchanger that facilitates heat transfer between the thermal fluid and the sea-water to warm the thermal fluid prior to its delivery to the superheater 744 or to the BOG tank 720 via fluid conduit 789 to be cooled prior to re-entry into the cooling header manifold 760. The thermal fluid circuit is then completed and begins again.

The thermal fluid is at a temperature of 21° C. as it enters the heat exchanger 770, having been warmed during the process of cooling equipment on the power barge 110 as described above. The thermal fluid is warmed further in the heat exchanger 770 by the sea-water passing through and leaves the heat exchanger 770 at a ‘cold’ outlet 776 at a temperature of 24° C. Sea-water is supplied to a ‘hot’ inlet 778 of the heat exchanger 770 from the ocean in a sea-water supply conduit 777 at a flow rate of 55 m³ per hour and at an ambient temperature of 26° C. The sea-water passes through the hot side of the heat exchanger 770 where some of its warmth is transferred to the thermal fluid, and exits at a ‘hot’ outlet 779 at a temperature of 24° C. and is returned to the ocean via fluid conduit 781.

The closed loop thermal circuit therefore utilises the latent energy released during vaporization of the LNG, captures it in the thermal fluid at the superheater 744 and utilises it efficiently to provide cooling for the gas turbine 112 inlet air, turbine lube oil and other equipment on the power barge 110 such as the air compressor 780 and the HVAC unit 782. This results in increases in overall power generation system efficiency.

The seawater is drawn from the sea into the power barge by a sea water pump 790. In FIG. 7d, three sea-water pumps 790 are shown each operable at a pressure of 5 bar and having a flow rate of 100 m³/hr. The sea-water is drawn into the sea-water pumps 790 through a sea-water supply conduit 792. The sea-water is distributed in a distribution conduit 794 for use in either the heat exchanger 780 at each of port and starboard side of the power barge 110 and a ballast system 795, located below deck, as indicated in FIG. 7d. The distribution conduit 794 supplies water to the starboard side sea-water supply conduit and a portion diverted into the port side sea-water supply conduit 777 for use in the port side heat exchanger 780.

Common practice in large scale LNG fuelled power generation plants is to include two or more thermal circuits, one capable of operation at cryogenic conditions, and another capable of operation at non-cryogenic conditions. The thermal circuit capable of operating at cryogenic conditions is generally unsuitable for use with systems operating at non-cryogenic temperatures as the extremely low temperatures may have a negative effect on those systems. The utilization of the latent energy of vaporisation of the LNG allows a single closed loop thermal circuit to be used that is not exposed to the cryogenic temperatures of the LNG.

FIGS. 8a-8c are schematic equipment diagrams of the gas turbine generator 112, the WHRU 516 and the ORC generator 114 as well as pipeline connections to each for natural gas, boil off gas and compressed air. The gas turbine generator 112 is shown in FIG. 8a. It includes an air inlet 802 which, in the illustrated example, comprises a three stage air intake filter. In some embodiments, the three stage air intake filter may comprise at least one low loss filter, such as a low loss filter for each stage, for example. Ambient air entering the air inlet 802 passes through the filters and into an air inlet conduit 804 which directs air into the gas turbine engine 112. The main components of the gas turbine engine 112 are not visible in FIG. 8a and consist of a compressor, combustion chamber 806, turbine and generator. The air inlet conduit 804 includes one or more chiller coils 808 through which the inlet air passes prior to its entry into the compressor of the gas turbine engine 112. The chiller coils 808 are fluidly connected to the thermal fluid supply conduit 783 for the supply of glycol thermal fluid at a temperature of 3° C. to the chiller coils 808. The ambient air enters the air inlet 802 at a temperature of 26° C. As it flows over the chiller coils 808, the inlet air is cooled to a temperature of about 15° C. prior to it being compressed in the compressor.

The combustion chamber 806 is fluidly connected to a supply of natural gas in supply conduit 812 that is in turn supplied with natural gas from each of the port and starboard transportation conduits 754 following vaporisation of the LNG in the vaporiser 730. The compressed air enters the combustion chamber 806 where it is sprayed with the natural gas and ignited. The resulting combusted gases expand at high velocity through the turbine, which rotates to drive the electrical power generator. Using the cold thermal fluid from the thermal circuit to reduce the temperature of the inlet air in the gas turbine 112 increases the efficiency of the gas turbine generator by approximately 10% and improves fuel efficiency by 3%.

In some embodiments, supply conduit 812 may also be fluidly connected to a supply of natural gas stored in a natural gas (NG) accumulator 896. NG accumulator 896 may be used to stored additional natural gas to be supplied to the combustion chamber 806 in the event that consumption suddenly increases, for example. That is, the NG accumulator 896 will supply additional natural gas to the gas turbine generator 112 should there be a sudden load draw from the gas turbine generator 112, for example. A size of the NG accumulator is selected to accommodate an expected difference resulting from GT fuel gas consumption and the dwell time it takes for the LNG process to make up the pressure.

The turbine is fluidly connected at an exit thereof to a turbine exhaust 814 for expulsion of the spent gases. The turbine exhaust is a conduit that exits to the atmosphere and is also fluidly connected to a duct 842 through which the exhaust gases may be selectively diverted for use in the WHRU 116 and therefore also in the ORC 114. A diverter damper 840 is pivotably installed in the turbine exhaust 814 to selectively divert the exhaust gases. The damper 840 is movable between a first position in which the gas turbine 112 and the ORC generator to operate together, and a second position in which the gas turbine 112 and the ORC generator 114 operate independently of each other. In the first position of the damper 840, the exhaust conduit (or exhaust stack) 814 is closed to the gases exiting the turbine, allowing the gases to instead flow into the duct 842. In the second position of the damper 840, the exhaust conduit is open to permit the gases exiting the gas turbine to enter the exhaust conduit 814 whilst the duct to the WHRU 116 is closed to the gases. In the embodiment shown, the diverter damper 840 consists of an air sealed damper but may take any suitable form that allows the selective diversion of gases from the turbine exhaust 840 to the WHRU 116. Equivalent diverter devices may also be used.

The duct 842 provides a fluid connection between the gas turbine 112 and the WHRU 116. Upstream of the WHRU 116 is a fresh air firing stack 844 that effectively replicates the turbine exhaust gases when the ORC generator 114 is to be operated independently. The fresh air firing stack 844 includes an air inlet 845 for the intake of fresh air into the stack 844. A fan 846 positioned in the air inlet draws air into the inlet 845 and through an air filter 847. An air blower 854 provides a further supply of fresh air into the fresh air firing stack 844 upstream of a combustion chamber 848. A supply of natural gas is diverted to a supply conduit 852 from the supply conduit 812, for providing fuel to at a valve 850 of the fresh air firing stack 844 at a pressure of 30 bar, flow rate of 1800 m³/hr and a temperature of 19° C. The fresh air is combusted with the natural gas in the combustion chamber 848 and the co-fired gases exit the fresh air firing stack 844 into the duct 842.

A further diverter damper 860 is pivotably installed in the duct 842 to selectively permit gases in the fresh air firing stack 844 to enter the duct 842. In the first position of the damper 860, the duct 842 is closed to the fresh air firing stack 844. In the second position of the damper 860, the duct 842 is open to permit co-fired gases exiting the fresh air firing stack 844 to enter the duct 842. The damper 860 consists of an air sealed damper but may take any suitable form that allows the opening and closing of the duct 842 to the fresh air firing stack 844.

Downstream of both the turbine exhaust 512 and the fresh air firing stack 844, the duct 842 is fluidly connected to the supplementary burner 830. The supplementary burner 830 includes a combustion chamber that receives ambient air from an air blower 856 and fuel in the form of BOG supplied to the combustion chamber via the supply conduits 722 from the BOG tank 720.

The turbine exhaust gases exit the gas turbine at a temperature of about 500° C. The co-fired gases exit the fresh air firing stack at about the same temperature. The exhaust gases or co-fired gases in the duct 842 enter the supplementary burner 830 and are ignited with the BOG to further heat the gases to a temperature of about 600° C. prior to the gases entering the WHRU 116. With this arrangement, the BOG is efficiently utilised to generate supplemental heat for operation of the ORC 114 through heat transfer from the burned BOG and exhaust/co-fired gases to the working fluid of the ORC. The position of the supplemental burner downstream of the gas turbine 112 and the fresh air firing stack 844 has the effect that the BOG is utilised regardless of whether the gas turbine 112 and the ORC 114 are operated independently or together.

The position of the damper 840 and the position of the damper 860 as well as the operation of the gas turbine 112 and the operation of the ORC generator 114 are controlled by a control system or controller 908 that may be operated from the control centre 115 on the power generation barge 110. The control system or controller 908 may be configured to monitor the electrical power load being drawn at the at least one remote power sink and to automatically control the operation of the gas turbine 112 and the ORC 114 in response to the monitored load being drawn.

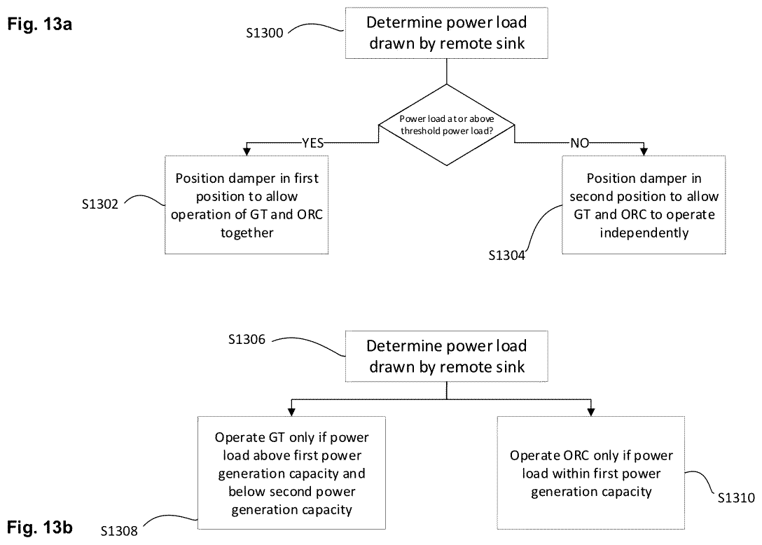

Whether the gas turbine 112 or the ORC 114 is operated on its own or whether the two are operated together in combined cycle depends on the electrical load being drawn by at least one remote power sink, for example the power substation 135 servicing an industrial facility or residential area. Normal operation of the power barge 110 assumes that the gas turbine 112 and the ORC will be operated in combined cycle, however this is not always efficient and it may be necessary to operate either the gas turbine 112 or the ORC 114 alone. FIG. 13A is a flowchart of the decision making process for positioning the damper 840. The power load being drawn by the remote sink is determined by the control system or controller 908 at step S1300. The ORC 114 has a first electrical power generation capacity and the gas turbine 112 has a second power generation capacity that is higher than the first power generation capacity. Where the load drawn by the at least one remote power sink is at or above a threshold power load, for example the second electrical power generation capacity of the gas turbine 112, the damper 840 is positioned at the first position at step S1302, to permit turbine exhaust gases to enter the duct 842 and to be utilised in the WHRU 116. If the load drawn at the at least one remote power sink falls beneath the threshold power load, then it is not efficient to operate the gas turbine 112 and the ORC 114 in combined cycle and the damper 840 is positioned in the second position at step S1304 to allow the gas turbine 112 and the ORC 114 to operate independently.

In this event, with the damper 840 positioned in the second position, either the gas turbine 112 is operated in simple cycle without the ORC 114 or the ORC 114 is operated independently without the gas turbine 112. FIG. 13B is a flowchart of the decision making process for whether to operate the gas turbine 112 or the ORC 114. The power load being drawn by the remote sink is determined by the control system or controller 908 at step S1306. If the power load drawn at the remote power sink is above the first electrical power generating capacity, i.e. the power generation capacity of the ORC 114, and below the second electrical power generation capacity, i.e. that of the gas turbine 112, the gas turbine 112 is operated alone in simple cycle at step S1308. If the power load drawn at the remote power sink is within the first electrical power generating capacity, the ORC 114 is operated alone in simple cycle without the gas turbine 112 at step S1310. If the gas turbine 122 is to be operated alone, positioning the damper 840 in the second position prevents turbine exhaust gases entering the duct 842 and instead exiting the gas turbine through the turbine exhaust 512. If the gas turbine 112 is not being operated, closing the damper 840 to the duct 842 ensures co-fired gases from the fresh air firing stack 844 flow in the direction of the supplementary burner 830. In this manner, the power barge 110 can operate at the most efficient level for the power load being drawn at any one time. The electrical power generating capacity of the gas turbine will depend on the particular gas turbine being used, therefore the threshold power load below which the damper 840 is positioned in the second position must be set for the particular gas turbine 112 being used. Accordingly, if the 15.6 MW Solar Titan 130 turbine is being used, then the power load threshold will be 15.6 MW. Similarly, if the ORC 114 has an electrical power generating capacity of 6 MW, the threshold power load below which only the ORC 114 will be operated is about 6 MW. Being able to operate the gas turbine 112 and the ORC generator 114 independently of one another also provides for some degree of redundancy should either generator require maintenance.

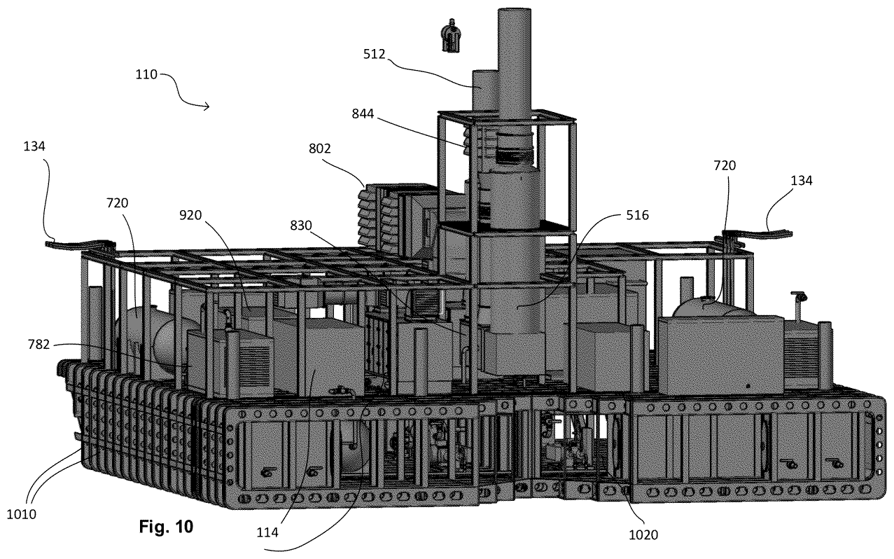

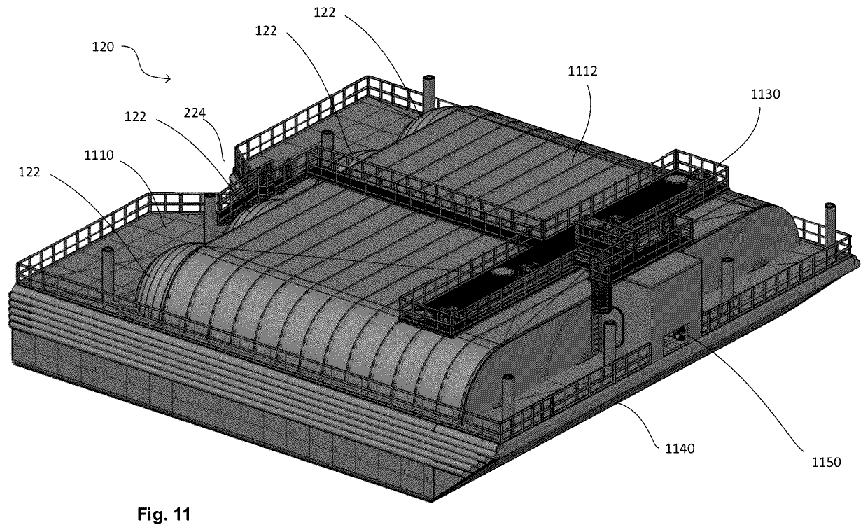

FIGS. 9 and 10 show the general layout of the power barge 110. Whilst not all equipment is visible in these figures, the LNG storage tanks 710, high pressure LNG pumps 716, sea water pumps 538 and glycol/thermal fluid recirculating pumps 534 are all located below deck. The control centre 115 is located on the main deck. For safety reasons, vaporizers 730 and BOG tanks 720 are also located on the main deck so that vaporized LNG is not stored in confined spaces below deck. A black start generator (BSG) 920 is located on the main deck for emergency re-start of the gas turbine 112. Alternatively, the black start generator 920 may be located on the floating pier 130 to reduce weight on the power generation barge 110. The gas turbine 112, ORC 114, WHRU 116, pumps 772 and heat exchangers 744,770 are all located on the main deck to provide for serviceability.

Ballast for the power generation barge 110 is controlled by adding and removing seawater to ballast tanks positioned below deck, as fuel is transferred from the storage barge 120 or consumed by the generation of power.

In FIG. 10, the deck 930 and hull 232 are removed to show the frame 230 of the power generation barge 110 in further detail. The frame 230 consists of multiple steel frame sections 1010 connected together in an open lattice framework to minimise weight whilst providing the necessary strength to support the plant equipment.

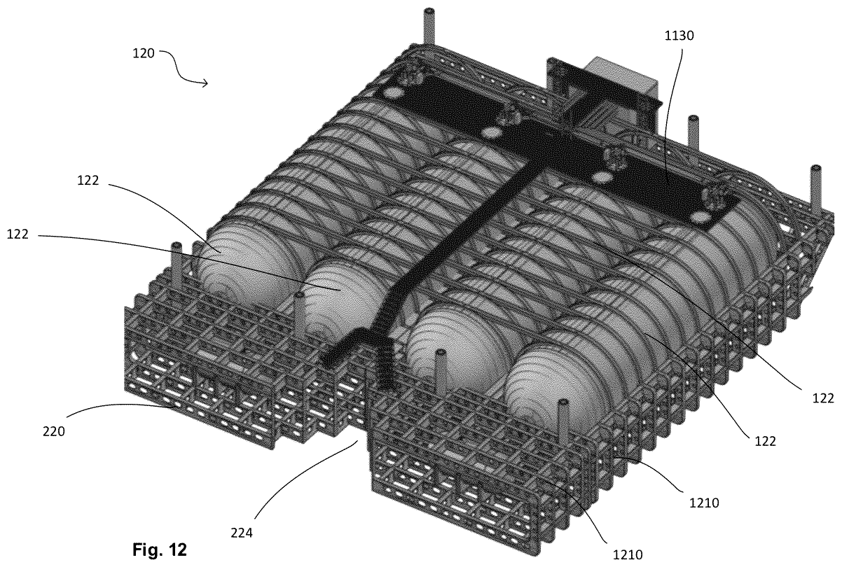

FIGS. 11 and 12 show the general layout of the LNG storage barge 120. As seen in FIG. 11, the deck 1110 of the vessel is free of plant equipment. Four LNG storage tanks 122 are positioned side by side within the vessel fame 220, extending fore-aft along the length of the vessel and distributed equally from port to starboard. The LNG storage tanks 122 are covered by a tank housing 1112. A gantry 1130 is installed above the tank housing 1112 for human access to the area and any equipment installed above each tank 122. The gantry 1130 is accessed from the deck 1110 by staircases fore and aft of the storage tanks 122. An interlock connection point 1150 at the fore end of the LNG storage barge 120 allows interlocking connection with the interlocking device 340 at the floating pier 130 for mooring of the LNG storage barge 120 in the mooring bay 310.

In FIG. 12, the deck 1110 and cover 1112 are removed to show the frame 220 of the LNG storage barge 120 in further detail. The frame 220 consists of multiple steel frame sections 1210 connected together in an open lattice framework to minimise weight whilst providing the necessary strength to support the LNG storage tanks 122.

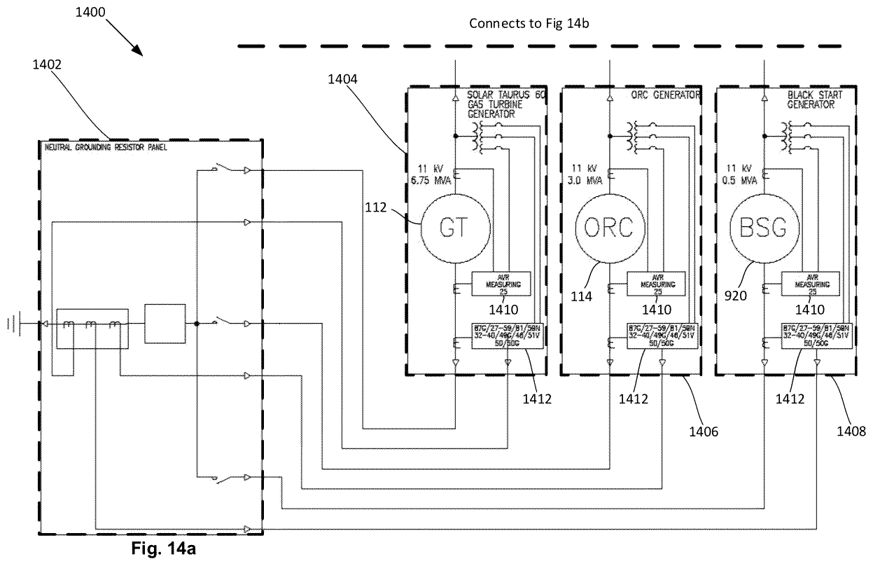

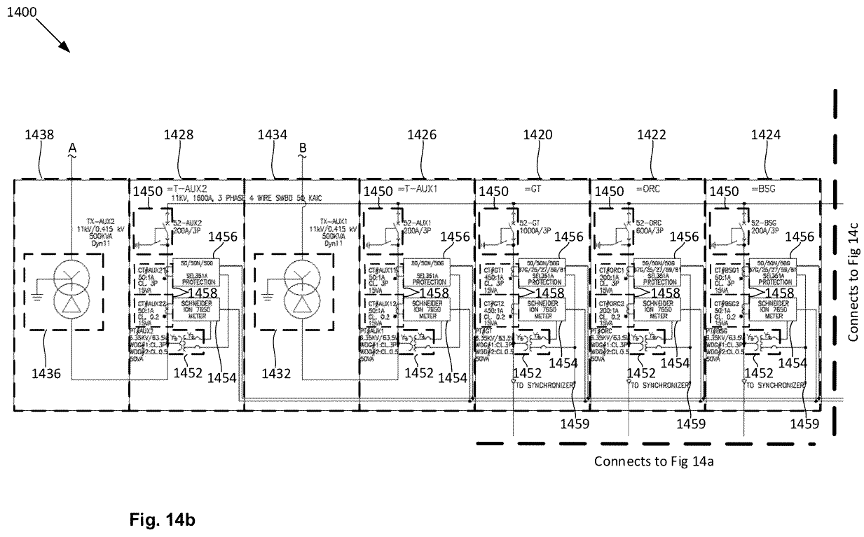

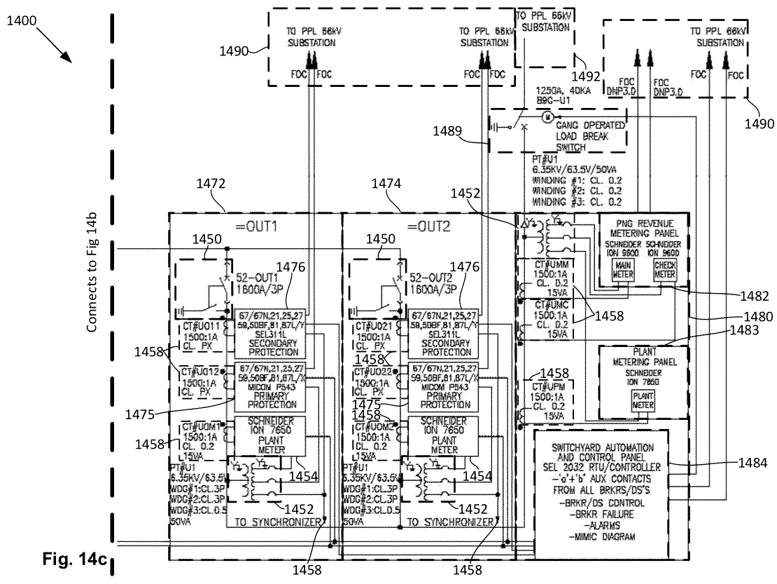

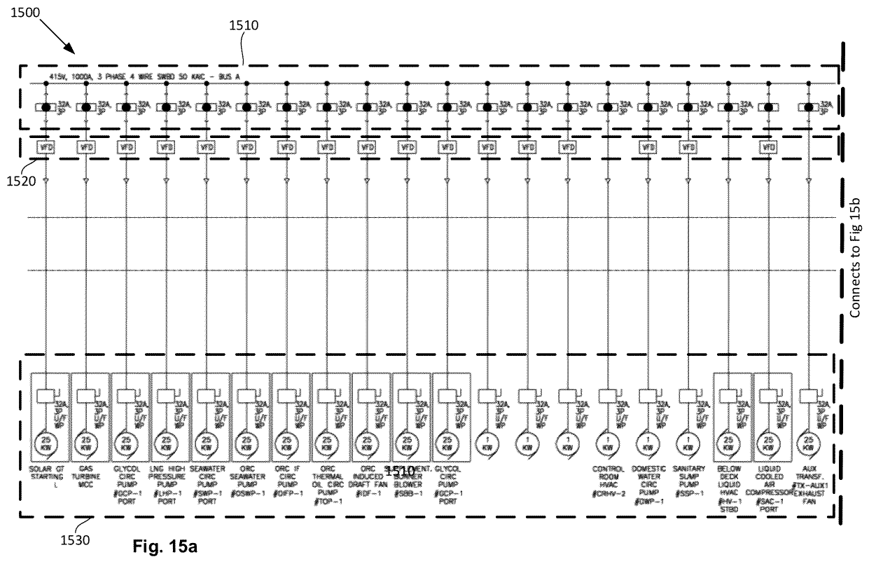

FIGS. 14a-c are 11 KV main electrical power single line diagrams of a main power system 1400, according to some embodiments. Reference lines as shown in FIGS. 14a-c indicate that the drawing shown is continued in another Figure. For example, the reference line of FIG. 14a marked with “Connects to FIG. 14b” is continued at the corresponding “Connects with FIG. 14a” on FIG. 14b. Similar logic applies to alternate reference lines shown on FIGS. 14a-c.

Referring to FIG. 14a, main power system 1400 may comprise a neutral grounding resistor panel (NGRP) 1402. NGRP 1402 may be used in main power system 1400 to protect electrical equipment, such as transformers and generators against fault events, such as short circuits, and transient phenomena, such as lightning, for example. NGRP 1402 may limit transient overvoltages to a safe value during a fault event or transient phenomena to avoid shutdown and damage of equipment within of main power system 1400. NGRP 1402 may reduce fault currents whilst still allowing sufficient flow of fault current to activate protection devices, for example.

Main power system 1400 further comprises gas turbine system 1404 to generate electrical energy using a gas turbine 112, as previously described. Gas turbine system 1404 may further comprise an automatic voltage regulator (AVR) 1410 to automatically maintain the output voltage of the gas turbine system 1404. That is, AVR 1410 may be used to regulate the output voltage of the gas turbine system 1404 at a predetermined voltage value, for example. Gas turbine system 1404 may further comprise protection device 1412.

Protection device 1412 may be used to provide overcurrent protection to main power system 1400. In some embodiments, protection device 1412 may provide some, or all, of the following protective features as outlined in “IEEE Standard C37.2 Standard for Electrical Power System Device Function Numbers, Acronyms, and Contact Designations” either separately, in combination, or both: 87G (Generator Differential), 27 (Undervoltage relay), 59 (Overvoltage Relay), 81 (Frequency Relay), 59N (Neutral Overvoltage), 32 (Directional Power Relay), 40 (Field Relay/Loss of Excitation), 49G (Machine or Transformer Thermal Relay/Thermal Overload Ground), 46 (Reverse-Phase or Phase Balance Current Relay or Stator Current Unbalance), 51V (Voltage Restrained Time Overcurrent), 50 (Instantaneous Overcurrent Relay), and/or 50G (Ground Instantaneous Overcurrent). In some embodiments, protection device 1412 may comprise a plurality of relays, for example.

Main power system 1400 further comprises ORC system 1406 to generate electrical energy using an ORC generator 114, as previously described. ORC system 1406 may further comprise an AVR 1410 and protection device 1412 to perform functions, as previously described. Main power system 1400 further comprises BSG system 1408 to generate electrical energy using an BSG generator 920. BSG system 1408 may be used to start gas turbine 112 of gas turbine system 1404, for example. BSG system 1408 may be used to start ORC generator 114 of ORC system 1406, for example. BSG system 1408 may further comprise an AVR 1410 and protection device 1412 to perform functions, as previously described.

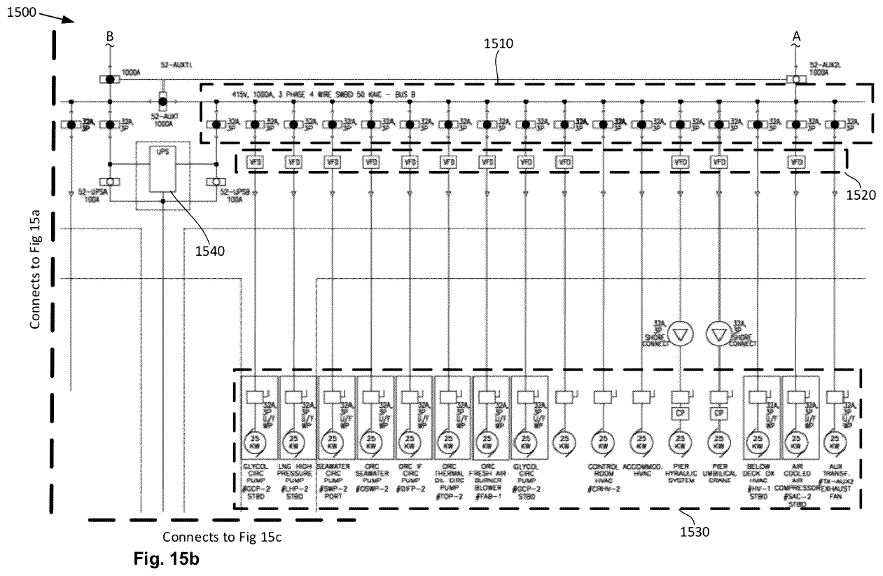

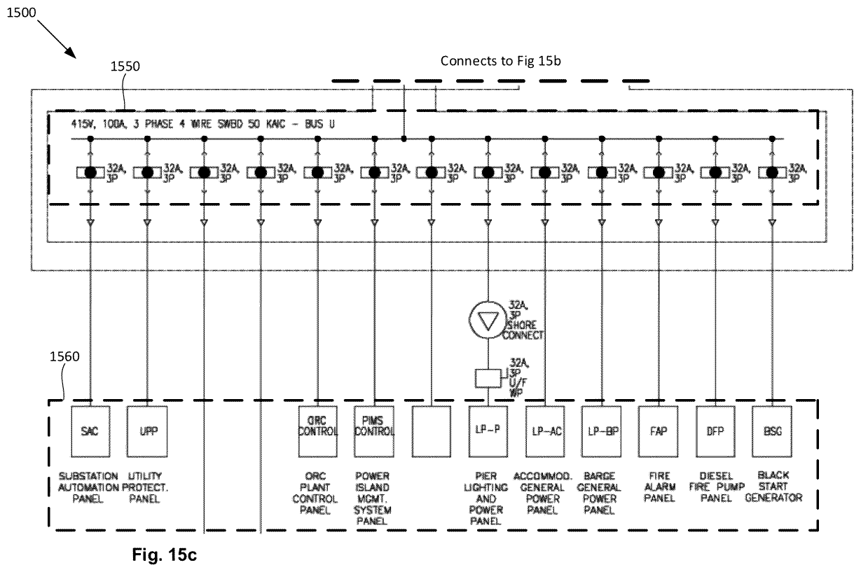

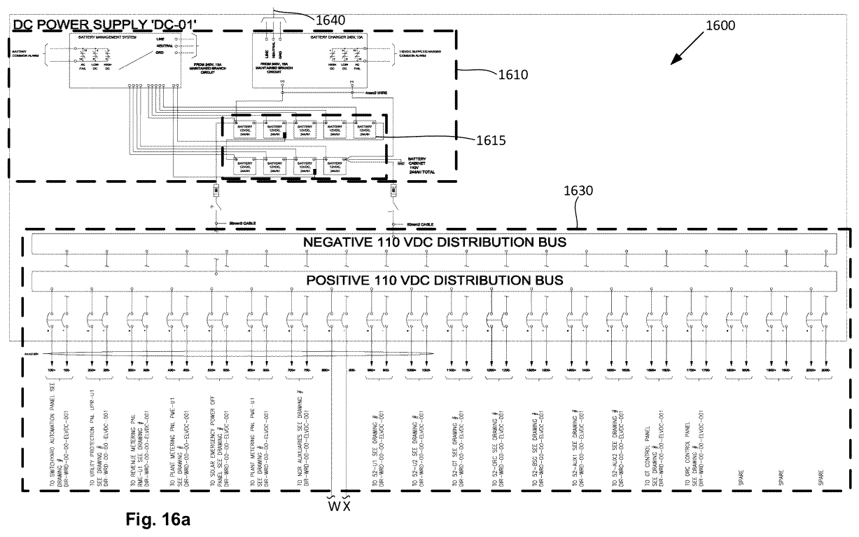

Referring to FIG. 14b, reference letters “A” and “B” indicate a continuation of a line from FIG. 14b to FIG. 15b. For example, the line of FIG. 14b marked with “A” is continued at the corresponding “A” on FIG. 15b. Similar logic also applies to “B” on FIGS. 14b and 15b.

Main power system 1400 further comprises monitoring and protection (MP) panels 1420, 1422, and 1424 in electrical communication with gas turbine system 1404, ORC system 1406, and BSG system 1408, respectively. Each MP panel 1420, 1422, and 1424 are used to monitor electrical power provided by their respective systems and to provide circuit protection in the event of a fault. MP panels 1420, 1422, and 1424 each comprise a circuit breaker 1450, a step down transformer 1452, a metering device 1454, a protection device 1456, and a plurality of current transformers 1458. In some embodiments, circuit breaker 1450 may be a three phase circuit breaker appropriately rated depending on the system that it is connected to. Circuit breaker 1450 may be rated at 1600A, 1000A, 600A, or 200A, for example. For example, MP panel 1420 which is in electrical communication with gas turbine system 1404 may be rated at 1000A to suit the electrical output of the gas generator 112. In some embodiments, circuit breaker 1450 may be a draw-out circuit breaker. That is, circuit breaker 1450 may be a circuit breaker that can be physically removed from the system during no-load conditions, for example.

Step down transformer 1452 may be used to step down the voltage input to each MP panel 1420, 1422, and 1424 to power other electrical components within the panel, such as metering device 1454 and protection device 1456. For example, MP panel 1420 receives an input voltage from gas turbine system 1404 which step down transformer 1452 reduces to an appropriate voltage to supply power to metering device 1454 and protection device 1456. In some embodiments, step down transformer 1452 may include circuit breakers in series with each secondary winding. That is, between each secondary winding and the connected electrical components, such as metering device 1454 and protection device 1456, there may be included a circuit breaker, for example.

Metering device 1454 may be used for some, or all, of the following: analysis of efficiency, losses, and capacity; bill verification, cost allocation, and sub-metering; power quality compliance monitoring; problem notifications and diagnosis; demand of power factor management; and control of loads, generators or other equipment. In some embodiments. Metering device 1454 may be an off the shelf device, such as a Schneider ION 7650, for example.

Protection device 1456 may be used to provide overcurrent protection to main power system 1400. In some embodiments, protection device 1456 may provide some, or all, of the following protective features as outlined in “IEEE Standard C37.2 Standard for Electrical Power System Device Function Numbers, Acronyms, and Contact Designations” either separately, in combination, or both: 50 (Instantaneous Overcurrent Relay), 50N (Neutral Instantaneous Overcurrent), 50G (Ground Instantaneous Overcurrent), 87G (Generator Differential), 25 (Synchronizing or synchronism-check device), 27 (Undervoltage relay), 59 (Overvoltage Relay), and/or 81 (Frequency Relay). Protection device 1456 may be an off the shelf device, such as a Selinc SEL-351A, for example.

In some embodiments, current transformers 1458 may be used to reduce the alternating current input to each MP panel 1420, 1422, and 1424 for use by metering device 1454 and protection device 1456. For example, MP panel 1420 receives an input alternating current from gas turbine system 1404 which current transformers 1458 reduces to an appropriate alternating current to provide to metering device 1454 and protection device 1456.

In some embodiments, each MP panel 1420, 1422, and 1424 comprises an electrical connection to a synchroniser 1459. Synchroniser 1459 may be used to ‘synchronise’ the frequencies of gas turbine system 1404, ORC system 1406, and BSG system 1408, to match the frequency of the running network, or system that is drawing power from the generators. When at least two of the gas turbine system 1404, ORC system 1406, or BSG system 1408 are providing electrical power to the running network at the same time, they must be synchronised so that they are providing power in parallel. In some embodiments, synchroniser 1459 may control operation of gas turbine system 1404, ORC system 1406, or BSG system 1408 so that they have equal line voltages, frequencies, phase sequences, phase angles, and waveforms to that of the running network to which they are being synchronised to.

Main power system 1400 may further comprise a first auxiliary transformer (T-AUX1) 1432 and a second auxiliary transformer (T-AUX2) 1436. T-AUX1 1432 and T-AUX2 1436 may be used to step down the high voltage supplied by the gas turbine system 1404, the ORC system 1406, or the BSG system 1408, either alone or in combination with one another, to a lower voltage usable by the barge power system 1500, to be described in relation to FIGS. 15a-c. For example, T-AUX1 1432 may step down a provided voltage of 11 kV to a lower voltage of 0.415 kV, or 415V. Similarly, T-AUX2 1436 may step down a provided voltage of 11 kV to a lower voltage of 0.415 kV, or 415V. In some embodiments, T-AUX1 1432 is a grounded wye-delta transformer, for example. In some embodiments, T-AUX2 1436 is a grounded wye-delta transformer, for example.

Main power system 1400 further comprises MP panels 1434 and 1438 for each of T-AUX1 1432 and T-AUX2 1436, respectively. MP panels 1434 and 1438 are used to monitor electrical power provided to the first and second auxiliary transformers 1432 and 1436 by gas turbine system 1404, ORC system 1406, and/or BSG system 1408 via their respective MP panels 1420, 1422, and 1424, and to provide circuit protection in the event of a fault. MP panels 1434 and 1438 each comprise a circuit breaker 1450, a step down transformer 1452, a metering device 1454, a protection device 1456, and a plurality of current transformers 1458. MP panels 1434 and 1438 function in the same manner as MP panels 1420, 1422, and 1424, as previously described.

Referring to FIG. 14c, main power system 1400 further comprises MP panels 1472 and 1474. MP panels 1472 and 1474 are used to monitor electrical power being output from main power system 1400 to an external power substation 135, and to provide circuit protection in the event of a fault. MP panels 1472 and 1474 each comprise a circuit breaker 1450, a step down transformer 1452, a metering device 1454, a first protection device 1475, a second protection device 1476, a plurality of current transformers 1458, and an electrical connection to synchroniser 1459. MP panels 1472 and 1474 function in the same manner as MP panels 1420, 1422, and 1424, as previously described. In some embodiments, the first and second protection devices 1475 and 1476, of MP panels 1472 and 1474, further include a fibre-optic cable (FOC) communication connection 1490 with the external power substation 135. That is, each of the first and second protection devices 1475 and 1476 and the metering device 1454, of MP panels 1472 and 1474, may provide data to and receive data from the external power substation 135, for example.

In some embodiments, the first protection device 1475 may provide some, or all, of the following protective features as outlined in “IEEE Standard C37.2 Standard for Electrical Power System Device Function Numbers, Acronyms, and Contact Designations” either separately, in combination, or both: 67 (AC Directional Overcurrent Relay), 67N (Neutral Directional Overcurrent), 21 (Distance Relay), 25 (Synchronizing or synchronism-check device), 27 (Undervoltage relay), 59 (Overvoltage Relay), 50BF (Overvoltage Relay Breaker Failure), 81 (Frequency Relay), 87L (Segregated Line Current Differential), and/or X (Auxiliary Relay). In some embodiments, the first protection device 1475 may be an off the shelf device, such as a MiCOM P543, for example.

In some embodiments, the second protection device 1476 may provide some, or all, of the following protective features as outlined in “IEEE Standard C37.2 Standard for Electrical Power System Device Function Numbers, Acronyms, and Contact Designations” either separately, in combination, or both: 67 (AC Directional Overcurrent Relay), 67N (Neutral Directional Overcurrent), 21 (Distance Relay), 25 (Synchronizing or synchronism-check device), 27 (Undervoltage relay), 59 (Overvoltage Relay), 50BF (Overvoltage Relay Breaker Failure), 81 (Frequency Relay), 87L (Segregated Line Current Differential), and Y (Auxiliary Relay). In some embodiments, the second protection device 1476 may be an off the shelf device, such as a Selinc SEL-311L, for example.

Main power system 1400 further comprises a main control panel 1480 to meter the output of electrical power from main power system 1400 and to monitor the main power system 1400. Main control panel 1480 comprises a step down transformer 1452, a revenue metering panel 1482, a plant metering panel 1483, a SAC panel 1484, and a plurality of current transformers 1458. Step down transformer 1452 and the plurality of current transformers 1458 function as previously described.

In some embodiments, revenue metering panel 1482 comprises a first and a second metering device 1454 for metering the output of main power system 1400 to the external substation 135. In some embodiments, the second metering device 1454 may be used to ensure that the first metering device 1454 is functioning as required. That is, the readings of the first metering device 1454 may be checked against the readings of the second metering device 1454 to ensure the device is functioning correctly, for example. The metering device 1454 of the revenue metering panel 1482 may be an off the shelf device, such as a Schneider ION 9600, for example. In some embodiments, revenue metering panel 1482 may further include at least one fibre-optic cable (FOC) communication connection 1490 with the external power substation 135.

In some embodiments, plant metering panel 1483 comprises a metering device 1454 to internally monitor the output of main power system 1400. Metering device 1454 of plant metering panel 1483 functions as previously described.

Switchyard automation control (SAC) panel 1484 may be used to monitor and control the main power system 1400. In some embodiments, SAC panel 1484 comprises a control unit. The control unit may be an off the shelf device, such as a SEL-2032, or a SEL-3530, or a SEL-3555, for example. SAC panel 1484 may be in communication with some, or all, of: the metering devices 1454 of MP panels 1420, 1422, 1424, 1426, 1428, 1472, and 1474, the protection devices 1456 of MP panels 1420, 1422, 1424, 1426, and 1428, and the first protection devices 1475 and the second protection devices 1476 of MP panels 1472 and 1474. In some embodiments, SAC panel 1484 may further include at least one fibre-optic cable (FOC) communication connection 1490 with the external power substation 135.

SAC panel 1484 may also be in communication with a switch 1489. Switch 1489, when actuated by SAC panel 1484, disconnects an the power substation 135, connected via an external power connection 1492, from the main power system 1400. In some embodiments, switch 1489 may be a gang operated load break switch, actuated by a motor, for example.

FIG. 15a-b are 415V barge electrical power single line diagrams of a barge power system 1500, according to some embodiments. Barge power system 1500 receives electrical power from mains power system 1400 via the connections marked with “A” and “B”, as shown on FIG. 15b. Barge power system 1500 comprises a plurality of power bus's 1510 to distribute power supplied by the main power system 1400 to a plurality of components within barge power system 1500. Barge power system 1500 further comprises a plurality of motors 1530. In some embodiments, the plurality of motors 1530 may include any one of a pump, a fan, an HVAC, a turbine, a hydraulic system, lighting, a crane system, for example. In some embodiments, the plurality of motors 1530 receive electrical power via the power bus 1510. Barge power system 1500 may further include a plurality of variable frequency drives (VFD) 1520. In some embodiments, some, or all, of the plurality of motors 1530 may receive electrical power from the power bus 1510 via a VFD 1520.

As shown in FIG. 15b, barge power system 1500 further comprises an uninterruptible power supply (UPS) 1540. UPS 1540 may be used to provide electrical power to a number of components in barge power system 1500 in the event of a fault or power failure. For example, a loss of electrical power from mains power system 1400 may cause UPS 1540 to activate to supply electrical power to a plurality of components of barge power system 1500, for example.

Referring to FIG. 15c, barge power system 1500 may further comprise power bus 1550 to distribute power supplied by the main power system 1400 to a plurality of control panels 1560 within barge power system 1500. In some embodiments, power bus 1550 may receive electrical power from UPS 1540 in the event of a fault or power failure, for example. The plurality of control panels 1560 may be used to control the various systems, electrical machinery, devices of barge power system 1500. For example, the plurality of control panels 1560 may control lighting, general electrical power, fire systems, and/or generators.

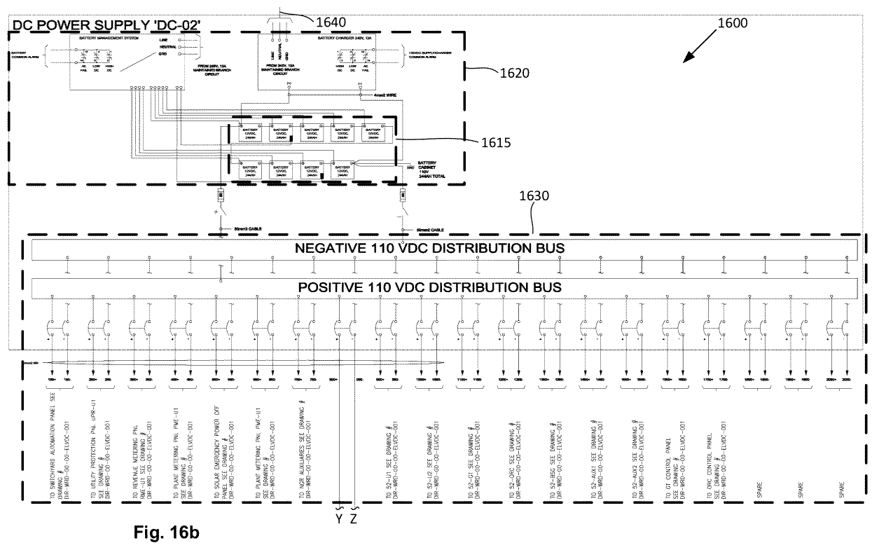

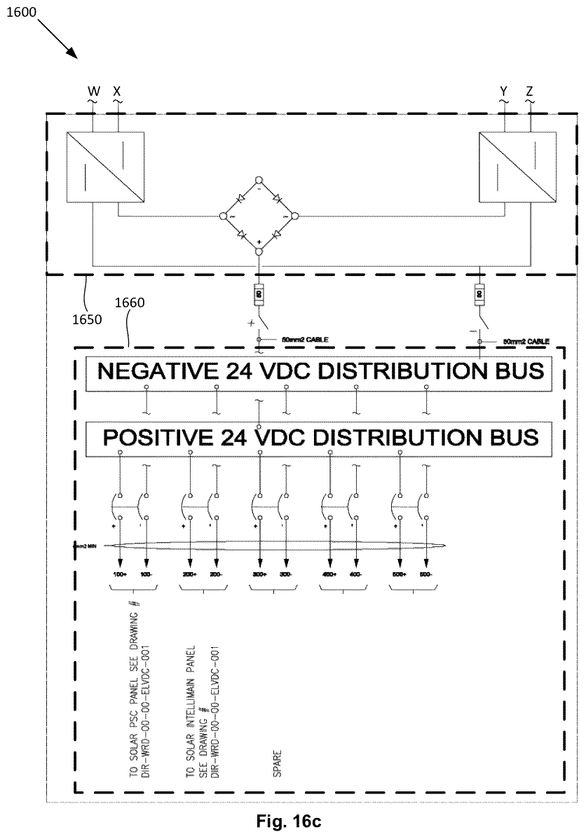

Referring to FIG. 16a, reference letters “W” and “X” indicate a continuation of a line from FIG. 16a to FIG. 16c. For example, the line of FIG. 16a marked with “W” is continued at the corresponding “W” on FIG. 16c. Similar logic also applies to “Y” and “Z” on FIGS. 16b and 16c.

FIGS. 16a-c are 110 VDC power generation barge electrical power single line diagrams of a barge DC power system 1600, according to some embodiments. Barge DC power system 1600 comprises a first battery system 1610 and a second battery system 1620. Each of the first battery system 1610 and the second battery system 1620 comprise a battery charger, a battery management system, and a battery array 1615, all in electrical communication with one another. In some embodiments, the battery charger receives an input electrical supply from connection 1640. The battery charger may use the input electrical supply to charge the battery array 1615. In some embodiments, the input electrical supply is rated at 240V, 13A. In some embodiments, the battery charger may convert the input electrical supply to a 110 VDC supply. In some embodiments, the battery array 1615 may comprise plurality of batteries.

Each of the first battery system 1610 and the second battery system 1620 supply electrical power, rated at 110 VDC, to a 110 VDC distribution bus 1630. In some embodiments, the second battery system 1620 may act as a failover power supply. That is, the second battery system 1620 may provide electrical power to the 110 VDC distribution bus 1630 in the event that the first battery system 1610 cannot, for example. The 110 VDC distribution bus 1630 may supply a 110 VDC electrical power supply to various systems and components of the off-shore power generation system 100. In some embodiments, distribution bus 1630 supplies electrical power to conversion interface circuitry 1650. Conversion interface circuitry 1650 converts the 110 VDC supply from the 110 VDC distribution bus 1630 to a 24 VDC electrical supply. The 24 VDC electrical supply is then supplied to a 24 VDC distribution bus 1660. In some embodiments, the 24 VDC distribution bus 1660 may supply a 24 VDC electrical power supply to various systems and components of the off-shore power generation system 100.

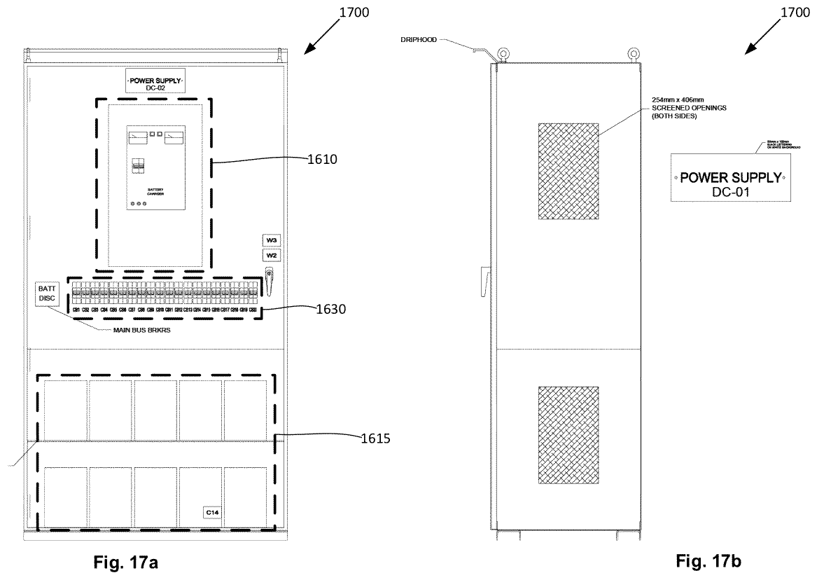

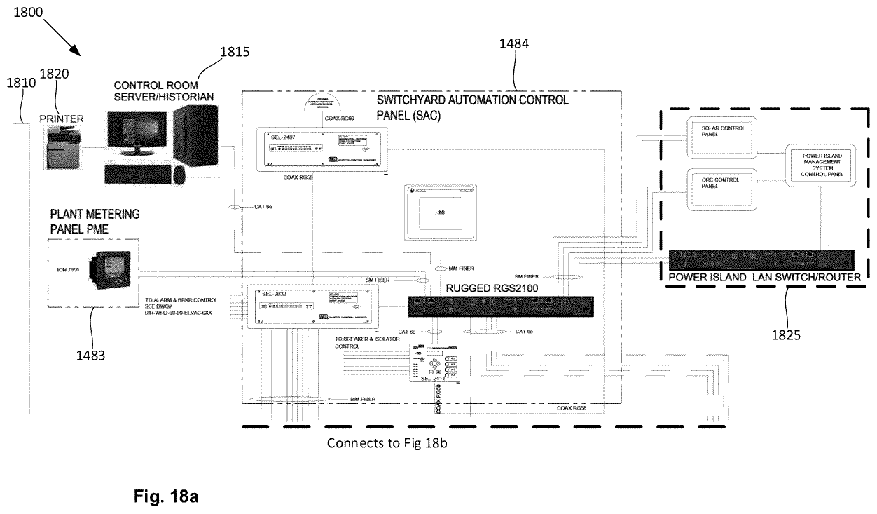

FIGS. 17a-b are schematic general arrangement diagrams of a 110 VDC power supply (DCPS) 1700, barge DC power system 1600, for example. In some embodiments, DCPS 1700 may be in the form of an electrical cabinet as shown in FIGS. 17a-b, for example. This electrical cabinet may be an off the shelf readily available electrical cabinet. In some embodiments, DCPS 1700 may house the barge DC power system 1600. In some embodiments, there may be a second DCPS 1700 to house elements of the barge DC power system 1600. That is, DCPS 1700 may contain the battery first battery system 1610, a battery array 1615, a 110 VDC distribution bus 1630 and a 24 VDC distribution bus 1660 and the second DCPS 1700 may contain the second battery system 1620, a battery array 1615, a 110 VDC distribution bus 1630 and a 24 VDC distribution bus 1660, for example.

FIG. 18a-b are schematic diagrams of an electrical power communications architecture 1800, according to some embodiments. At least part of electrical power communications architecture 1800 may be located in control centre 115. FIGS. 18a-b provide a graphical representation of the data communications between SAC panel 1484 and MP panels 1420, 1422, 1424, 1426, 1428, 1472, and 1474, and plant metering panel 1483. That is, electrical power communications architecture 1800 comprises SAC panel 1484, MP panels 1420, 1422, 1424, 1426, 1428, 1472, 1474, and plant metering panel 1483. In some embodiments, electrical power communications architecture 1800 may further comprise external communications connections 1810. External communications connection 1810 may provide communications between electrical power communications architecture 1800 and external computing devices, for example.

In some embodiments, electrical power communications architecture 1800 may further comprise a control room computing device 1815. Control room computing device 1815 may allow a user to control and monitor the systems and components of electrical power communications architecture 1800, for example. In some embodiments, electrical power communications architecture 1800 may further comprise a printer 1820 or other peripheral devices in communication with the control room computing device 1815. In some embodiments, electrical power communications architecture 1800 may further comprise barge power system control panels 1825. Power system control panels 1825 may include some, or all, of the control panels used to control the systems of the off-shore power generation system 100, for example.

It will be appreciated by persons skilled in the art that numerous variations and/or modifications may be made to the above-described embodiments, without departing from the broad general scope of the present disclosure, including the following clauses. The present embodiments are, therefore, to be considered in all respects as illustrative and not restrictive.

Clause 1. A power generation system, comprising: a gas turbine to generate electrical power from combustion of natural gas; a gas supply line for supplying vaporised liquefied natural gas (LNG) to the gas turbine; a power supply subsystem to receive electrical power from the gas turbine and to supply power to at least one remote power sink; a vaporiser configured for vaporising the LNG; and a closed loop thermal fluid circuit configured to recover latent energy of the vaporising LNG to cool a thermal fluid in the closed loop thermal fluid circuit, wherein the gas turbine includes an air inlet for the intake of ambient air; and wherein the air inlet is configured such that ambient air passing there through is cooled by the cooled thermal fluid.

Clause 2. The system of clause 1, wherein the gas turbine includes a lubricant oil cooler and wherein the thermal fluid circuit is configured to exchange heat energy with lubricant oil in the lubricant oil cooler, to thereby cool the lubricant oil and heat the thermal fluid.

Clause 3. The system of clause 2, wherein the thermal fluid circuit includes a heat exchanger in which the thermal fluid exchanges heat energy with seawater passing through the heat exchanger, to thereby further heat the thermal fluid prior to its return to the vaporiser.

Clause 4. The system of any one of clauses 1 to 3, wherein a portion of the thermal fluid cooled at the vaporiser is diverted from the thermal fluid circuit for use in cooling air conditioning equipment and/or compressor equipment.

Clause 5. The system of any one of any one of clauses 1 to 4, further including an organic Rankine cycle (ORC) generator to generate electrical power from heat recovery, wherein the power supply subsystem is configured to receive electrical power from at least one of the gas turbine or the ORC generator to supply power to the at least one remote power sink.

Clause 6. The system of clause 5, wherein the ORC generator is configured for electrical power generation in addition to the gas turbine or in substitution for the gas turbine.

Clause 7. The system of clause 5 or clause 6, wherein the ORC generator includes a fresh air firing stack and is configured to generate electrical power from heat recovered from exhaust gases exiting the gas turbine and/or from gases entering the ORC from the fresh air firing stack.

Clause 8. The system of any one of clauses 5 to 7, further including a supplementary burner arranged downstream of the fresh air firing stack and in fluid communication with at least one storage tank to receive boil-off gas from one or more LNG storage tank; wherein the supplementary burner is adapted to burn the boil-off gas to generate supplemental heat for operation of the ORC generator.

Clause 9. The system of clause 8, wherein the thermal fluid of the closed loop thermal fluid circuit and/or of the ORC generator is used to heat and thereby increase the pressure of the boil-off-gas prior to the boil-off-gas entering the supplementary burner.

Clause 10. The system of any one of clauses 5 to 9, further including a damper which, in a first position allows the gas turbine and the ORC generator to operate together, and in a second position allows the gas turbine and ORC generator to operate independently of each other.

Clause 11. The system of any one of clauses 5 to 10, wherein the ORC generator has a first electrical power generation capacity and the gas turbine has a second electrical power generation capacity that is higher than the first electrical power generation capacity.

Clause 12. The system of any one of clauses 5 to 11, wherein a working fluid of the ORC generator is a thermal fluid.

Clause 13. The system of clause 12, further including a heat exchanger configured to receive heated gases from the supplemental burner and for heating the thermal fluid of the ORC generator.

Clause 14. The system of clause 12 or clause 13, wherein the ORC generator includes a condenser configured to condense the thermal fluid using seawater as a coolant.

Clause 15. The system of any one of clauses 5 to 14, wherein the ORC generator comprises a radial expander.

Clause 16. The system of clause 15, wherein the radial expander includes variable inlet vanes that are controllable to enable adjustment of electrical power output of the ORC generator in response to transient power load drawn by the at least one remote power sink.

Clause 17. The system of any one of clauses 5 to 14, wherein the ORC comprises an axial expander controllable to enable adjustment of electrical power output of the ORC generator in response to transient power load drawn by the at least one remote power sink.

Clause 18. The system of any one of clauses 1 to 17, wherein the gas turbine has a power output of between about 5 MW and about 20 MW.

Clause 19. The system of any one of clauses 5 to 18, wherein the ORC generator has a power output of between about 3 MW and about 7 MW.

Clause 20. The system of any one of clauses 1 to 19, wherein the thermal fluid of the closed loop thermal fluid circuit and/or of the ORC generator is one of glycol and a thermal oil.

Clause 21. The system of any one of clauses 1 to 20, wherein the thermal fluid of the closed loop thermal fluid circuit and/or of the ORC generator has a working temperature of between about 3° C. and about 24° C.

Clause 22. A floating power generation system, comprising the system of any one of clauses 1 to 21 installed on a vessel, the vessel including a vessel frame, a hull around the vessel frame and defining fore and aft sections, and a deck supported by the vessel frame; wherein the power supply subsystem is configured to supply power to at least one remote power sink that is away from the vessel.

Clause 23. The system of clause 22, wherein the vessel is free of propulsion means.

Clause 24. The system of clause 22 or clause 23, wherein the vessel is formed as a barge.

Clause 25. The system of any one of clauses 22 to 24, further comprising at least one LNG storage tank on the vessel.

Clause 26. A power generation system, comprising: a gas turbine to generate electrical power from combustion of natural gas; an organic Rankine cycle (ORC) generator to generate electrical power from heat recovery; a gas supply line for supplying vaporised liquefied natural gas (LNG) to the gas turbine; a power supply subsystem to receive electrical power from at least one of the gas turbine or the ORC generator and to supply power to at least one remote power sink; and a damper which, in a first position allows the gas turbine and the ORC generator to operate together, and in a second position allows the gas turbine and ORC generator to operate independently of each other.

Clause 27. The system of clause 26, wherein the ORC generator has a first electrical power generation capacity and the gas turbine has a second electrical power generation capacity that is higher than the first electrical power generation capacity.

Clause 28. The system of clause 26 or clause 27, further including a controller configured to control the position of the damper at either the first position or the second position, in response to variation of a load drawn by the at least one remote power sink.

Clause 29. The system of any one of clauses 26 to 28, wherein the controller is configured to position the damper at the first position when the load drawn by the at least one remote power sink is at or above a first threshold power load and to position the damper at the second position when the load drawn by the at least one remote power sink is below the first threshold power load.

Clause 30. The system of clause 29, wherein the first threshold power load corresponds to the second electrical power generation capacity.

Clause 31. The system of any one of clauses 26 to 30, wherein the gas turbine is arranged in selective fluid communication with a) an exhaust stack and b) the ORC generator, whereby in the first position of the damper, a fluid flow path from the gas turbine to the exhaust stack is closed to gases exiting the gas turbine, and a fluid flow path from the gas turbine to the ORC generator is open, allowing the gases exiting the gas turbine to flow into the ORC generator.

Clause 32. The system of clause 31, wherein in the second position of the damper, the fluid flow path from the gas turbine to the exhaust stack is open to permit the gases exiting the gas turbine to enter the exhaust stack, and the fluid flow path from the gas turbine to the ORC generator is closed to the gases exiting the gas turbine.

Clause 33. The system of any one of clauses 26 to 32, wherein the damper comprises at least one air sealed damper.

Clause 34. The system of any one of clauses 26 to 33, wherein the ORC generator includes a fresh air firing stack and is configurable to generate electrical power from heat recovered from exhaust gases exiting the gas turbine and/or from gases entering the ORC generator via the fresh air firing stack.

Clause 35. The system of clause 34, wherein the ORC generator is configurable to generate electrical power from gases entering the ORC generator via the fresh air firing stack when a load drawn by the at least one remote power sink is below a second threshold power load.

Clause 36. The system of clause 34 or clause 35, wherein the fresh air firing stack is positioned downstream of the gas turbine.

Clause 37. The system of any one of clauses 34 to 36, further including a supplementary burner arranged downstream of the fresh air firing stack and in fluid communication with at least one storage tank to receive boil-off gas from one or more LNG storage tank; wherein the supplementary burner is adapted to burn the boil-off gas to generate supplemental heat for operation of the ORC generator.

Clause 38. The system of clause 37, further including a heat exchanger configured to receive heated gases from the supplemental burner and for heating a working fluid of the ORC generator.

Clause 39. The system of any one of clauses 26 to 38, wherein a fuel source of the gas turbine generator and the ORC generator is LNG.

Clause 40. A floating power generation system, comprising the system of any one of clauses 26 to 39 installed on a vessel, the vessel including a vessel frame, a hull around the vessel frame and defining fore and aft sections, and a deck supported by the vessel frame; wherein the power supply subsystem is configured to supply power to at least one remote power sink that is away from the vessel.

Clause 41. A method of controlling the operation of the power generation system of any one of clauses 26 to 40, comprising controlling the position of the damper to be in either the first position allowing the gas turbine and the ORC generator to operate together, or in the second position allowing the gas turbine and ORC generator to operate independently of each other.

Clause 42. The method of clause 41, wherein the damper is positioned in the first position when the load drawn by the at least one remote power sink is at or above the first threshold power load.

Clause 43. The method of clause 41 or clause 42, wherein the damper is positioned in the second position when the load drawn by the at least one remote power sink is below a first threshold power load.

Clause 44. The method of any one of clauses 41 to 43, wherein the first threshold power load corresponds to the second electrical power generation capacity.

Clause 45. The method of any one of clauses 41 to 44, wherein the power generation system is controlled to operate either the gas turbine or the ORC generator in response to a power load drawn by the at least one remote power sink.

Clause 46. The method of clause 45, wherein the power generation system is controlled to operate the gas turbine and not the ORC generator when the power load drawn is above a second threshold power load and below a first threshold power load.

Clause 47. The method of clause 45 or clause 46, wherein the power generation system is controlled to operate the ORC generator and not the gas turbine when the power load drawn is within the second threshold power load.

Clause 48. The system of clause 46 or clause 47, wherein the second threshold power load corresponds to the first electrical power generation capacity and the first threshold power load corresponds to the second electrical power generation capacity.

Clause 49. A storage system for liquefied natural gas (LNG), comprising: a floatable vessel formed as a barge, the vessel including: a vessel frame, a hull around the vessel frame and defining fore and aft sections, and a deck supported by the vessel frame; at least two LNG storage tanks carried by the vessel frame, including a first LNG storage tank positioned on a port side of the vessel and a second LNG storage tank positioned on a starboard side of the vessel; fluid transport conduits connected to the at least two LNG storage tanks to allow fluid flow into and out of the at least two LNG storage tanks; and a valve system to control flow of fluid in the fluid transport conduits; wherein the vessel frame and the hull define a broad and shallow draught.

Clause 50. The system of clause 49, wherein the vessel is free of in-built propulsion means.

Clause 51. The system of clause 49 or clause 50, wherein the vessel has a recess defined in a central part of the aft section to receive a prow of a driving vessel.

Clause 52. The system of any one of clauses 49 to 51, wherein the fore section of the hull has an acutely angled surface to facilitate forward passage of the vessel through water.

Clause 53. The system of any one of clauses 49 to 52, further comprising at least one ballast pump to draw seawater into the hull for ballast control.

Clause 54. The system of clause 53, further comprising at least one compressed air storage tank to supply compressed air for operating the at least one ballast pump.

Clause 55. The system of clause 53 or clause 54, further comprising a pump control interface to allow control of the at least one ballast pump by an external controller when an external control conduit is coupled to the pump control interface.

Clause 56. The system of any one of clauses 49 to 55, further comprising at least one pneumatic pump to draw LNG from the at least two LNG storage tanks into the fluid transport conduits.

Clause 57. The system of clause 56, further comprising at least one compressed air storage tank to supply compressed air for operating the at least one pneumatic pump.

Clause 58. The system of any one of clauses 49 to 57, wherein each of the at least two LNG storage tanks has a boil-off gas (BOG) exhaust conduit coupled thereto to allow boil-off gas to be exhausted to a BOG storage tank.

Clause 59. The system of any one of clauses 49 to 58, wherein a collective volumetric capacity of the at least two LNG storage tanks is between about 1000 m³ and about 6000 m³.

Clause 60. The system of clause 59, wherein the collective volumetric capacity is between about 1500 m³ and about 4000 m³.

Clause 61. The system of clause 59, wherein the collective volumetric capacity is between about 2000 m³ and about 3500 m³.

Clause 62. The system of any one of clauses 59 to 61, wherein the at least two LNG storage tanks comprises two to four LNG storage tanks with a collective volumetric capacity of about 3000 m³.

Clause 63. The system of any one of clauses 49 to 62, wherein the vessel is free of plant on the deck.

Clause 64. A floating LNG storage installation, including: a floating pier secured by fixed piles positioned proximate a shoreline; at least one LNG storage system according to any one of clauses 49 to 63 moored to the floating pier.

Clause 65. The installation of clause 64, wherein multiple ones of the LNG storage system are moored to the floating pier.

Clause 66. The installation of clause 64 or clause 65, further including a floating power generation system moored to the floating pier and configured to generate power from LNG, wherein the at least one LNG storage system is configured to supply LNG via the fluid transport conduits to the floating power generation system.

Clause 67. The installation of any one of clauses 64 to 66, wherein the multiple ones of the LNG storage system are each moored to the floating pier through the use of an interlocking device.

Clause 68. The installation of clause 67, wherein the interlocking device is a mechanical mechanism for restricting movement.

Clause 69. The installation of clause 67 or clause 68, wherein the interlocking device is a hydraulic pin.

Clause 70. The installation of any one of clauses 64 to 69, wherein the floating pier is configured to rise and fall with sea conditions relative to the fixed piles.

Clause 71. A floating LNG storage installation, including: a floating pier secured by fixed piles positioned proximate a shoreline; at least one mooring bay configured to accommodate a LNG storage system according to any one of clauses 49 to 63; a bulk LNG storage facility at an end of the floating pier that is farthest from the shoreline, the bulk LNG storage facility having a LNG storage capacity sufficient to refuel at least two of the LNG storage systems.

Clause 72. The floating LNG storage installation of clause 71, wherein the bulk LNG storage facility has a LNG storage capacity sufficient to refuel at least four of the LNG storage systems.

Clause 73. The installation of clause 71 or clause 72, wherein the at least one mooring bay is configured to moor the LNG storage system according to any one of clauses 1 to 15 through the use of an interlocking mechanism.

Clause 74. The installation of clause 73, wherein the interlocking device is a mechanical mechanism for restricting movement.

Clause 75. The installation of clause 73 or clause 74, wherein the interlocking device is a hydraulic pin.

Clause 76. The installation of any one of clauses 71 to 75 wherein the floating pier is configured to rise and fall with sea conditions relative to the fixed piles.

Clause 77. A floating power generation system, comprising: a vessel, the vessel including: a vessel frame, a hull around the vessel frame and defining fore and aft sections, and a deck supported by the vessel frame; a gas turbine on the vessel to generate electrical power from combustion of natural gas; an organic Rankine cycle (ORC) generator on the vessel to generate electrical power from heat recovery; a gas supply line on the vessel for supplying liquefied natural gas (LNG) to the gas turbine; and a power supply subsystem to receive electrical power from at least one of the gas turbine or the ORC generator and to supply power to at least one remote power sink that is away from the vessel.

Clause 78. The system of clause 77, wherein the vessel is free of propulsion means.

Clause 79. The system of clause 77 or clause 78, wherein the vessel has a recess defined in a central part of the aft section to receive a prow of a driving vessel.

Clause 80. The system of any one of clauses 77 to 79, wherein the fore section of the hull has an acutely angled surface to facilitate forward passage of the vessel through water.

Clause 81. The system of any one of clauses 77 to 80, wherein the vessel is formed as a barge.

Clause 82. The system of any one of clauses 77 to 81, further comprising at least one LNG storage tank on the vessel.

Clause 83. The system of clause 82, wherein the at least one LNG storage tank includes a plurality of LNG storage tanks disposed below the deck.

Clause 84. The system of any one of clauses 77 to 83, wherein the ORC generator is configured to be used for electrical power generation in addition to the gas turbine or in substitution for the gas turbine.

Clause 85. The system of any one of clauses 77 to 84, wherein the ORC generator has a first electrical power generation capacity and the gas turbine has a second electrical power generation capacity that is higher than the first electrical power generation capacity.

Clause 86. The system of clause 85, wherein the power supply subsystem is configured to vary operation of the ORC generator in response to variation of load drawn by the at least one remote power sink when the gas turbine and the ORC generator are operating simultaneously to generate electrical power and when the variation of load is within the first electrical power generation capacity.

Clause 87. The system of any one of clauses 77 to 86, wherein the ORC generator comprises a radial expander.

Clause 88. The system of clause 87, wherein the radial expander includes variable inlet vanes that are controllable to enable adjustment of electrical power output of the ORC generator.

Clause 89. The system of any one of clauses 77 to 88, wherein the gas turbine has a power output of between about 5 MW and about 20 MW.

Clause 90. The system of any one of clauses 77 to 89, wherein the ORC generator has a power output of between about 2 MW and about 6 MW.

Clause 91. The system of any one of clauses 77 to 90, further including: at least one storage tank to receive boil-off gas from one or more LNG storage tank; and a supplementary burner to burn the boil-off gas to generate supplemental heat for operation of the ORC generator.

Clause 92. The system of any one of clauses 77 to 91, further including a damper which, in a first position allows the gas turbine and the ORC generator to operate together, and in a second position allows the gas turbine and ORC generator to operate independently of each other.

Clause 93. The system of any one of clauses 77 to 92, wherein the ORC generator includes a fresh air firing stack.

Clause 94. A power generation installation, comprising: a floating pier coupled to fixed pylons and configured to move up and down with water level relative to the fixed pylons, the floating pier being positioned to allow access to the floating pier from a shoreline; at least one floating power generation system of any one of clauses 77 to 93 moored to the floating pier; and at least one floating LNG storage vessel moored to the floating pier to supply LNG to the at least one floating power generation system.

Clause 95. The installation of clause 94, wherein the floating pier comprises: a gangway to allow human access; at least one first bay for receiving the at least one floating power generation system, respectively; and at least one second bay for receiving the at least one floating LNG storage vessel, respectively.

Clause 96. The installation of clause 95, wherein the at least one floating power generation system is moored closer to the shoreline than the at least one floating LNG storage vessel.

Clause 97. The installation of any one of clauses 94 to 96, wherein the at least one floating power generation system is moored to the floating pier through the use of an interlocking device.

Clause 98. The installation of any one of clauses 94 to 97, wherein the at least one floating LNG storage vessel is moored to the floating pier through the use of an interlocking device.

Clause 99. The installation of clause 97 or clause 98, wherein the interlocking device is a mechanical mechanism for restricting movement.

Clause 100. The installation of any one of clauses 97 to 99, wherein the interlocking device is a hydraulic pin.

1. A floating power generation system, comprising:
a vessel, the vessel including: a vessel frame, a hull around the vessel frame and defining fore and aft sections, and a deck supported by the vessel frame;
a gas turbine on the vessel to generate electrical power from combustion of natural gas;
an organic Rankine cycle (ORC) generator on the vessel to generate electrical power from heat recovery;
a gas supply line on the vessel for supplying liquefied natural gas (LNG) to the gas turbine; and
a power supply subsystem to receive electrical power from at least one of the gas turbine or the ORC generator and to supply power to at least one remote power sink that is away from the vessel.

2. The system of claim 1, wherein the vessel is free of propulsion means.

3. The system of claim 1, wherein the vessel has a recess defined in a central part of the aft section to receive a prow of a driving vessel.

4. The system of claim 1, wherein the fore section of the hull has an acutely angled surface to facilitate forward passage of the vessel through water.

5. The system of claim 1, wherein the vessel is formed as a barge.

6. The system of claim 1, further comprising at least one LNG storage tank on the vessel.

7. The system of claim 6, wherein the at least one LNG storage tank includes a plurality of LNG storage tanks disposed below the deck.

8. The system of claim 1, wherein the ORC generator is configured to be used for electrical power generation in addition to the gas turbine or in substitution for the gas turbine.

9. The system of claim 1, wherein the ORC generator has a first electrical power generation capacity and the gas turbine has a second electrical power generation capacity that is higher than the first electrical power generation capacity.

10. The system of claim 9, wherein the power supply subsystem is configured to vary operation of the ORC generator in response to variation of load drawn by the at least one remote power sink when the gas turbine and the ORC generator are operating simultaneously to generate electrical power and when the variation of load is within the first electrical power generation capacity.

11. The system of claim 1, wherein the ORC generator comprises a radial expander.

12. The system of claim 11, wherein the radial expander includes variable inlet vanes that are controllable to enable adjustment of electrical power output of the ORC generator.

13. The system of claim 1, wherein the gas turbine has a power output of between about 5 MW and about 20 MW.

14. The system of claim 1, wherein the ORC generator has a power output of between about 2 MW and about 6 MW.

15. The system of claim 1, further including: at least one storage tank to receive boil-off gas from one or more LNG storage tank; and a supplementary burner to burn the boil-off gas to generate supplemental heat for operation of the ORC generator.

16. The system of claim 1, further including a damper which, in a first position allows the gas turbine and the ORC generator to operate together, and in a second position allows the gas turbine and ORC generator to operate independently of each other.

17. The system of claim 1, wherein the ORC generator includes a fresh air firing stack.

18. A power generation installation, comprising:
a floating pier coupled to fixed pylons and configured to move up and down with water level relative to the fixed pylons, the floating pier being positioned to allow access to the floating pier from a shoreline;
at least one floating power generation system of claim 1 moored to the floating pier; and
at least one floating LNG storage vessel moored to the floating pier to supply LNG to the at least one floating power generation system.

19. The installation of claim 18, wherein the floating pier comprises: a gangway to allow human access; at least one first bay for receiving the at least one floating power generation system, respectively; and at least one second bay for receiving the at least one floating LNG storage vessel, respectively.

20. The installation of claim 19, wherein the at least one floating power generation system is moored closer to the shoreline than the at least one floating LNG storage vessel.

21. The installation of claim 18, wherein the at least one floating power generation system is moored to the floating pier through the use of an interlocking device.

22. The installation of claim 18, wherein the at least one floating LNG storage vessel is moored to the floating pier through the use of an interlocking device.

23. (canceled)

24. (canceled)
